(19) United States
(12) Patent Application Publication
(10) Pub. No.: US 2025/0321353 A1
(43) Pub. Date: Oct. 16, 2025

(54) Natural Disaster Shed Data Based Home Hazard and/or Vulnerability Model Networks and System Management

(71) Applicant: Delos Space Corporation dba Delos Insurance Solutions, San Francisco, CA (US)

(72) Inventors: Andrew Chin Notohamiprodjo, Livermore, CA (US); Kevin Anand Stein, Alameda, CA (US); Shanna Marie Mclntyre, Oakland, CA (US)

(21) Appl. No.: 18/631,967

(22) Filed: Apr. 10, 2024

(51) Int. Cl. G01W 1/10

(52) U.S. Cl. CPC G01W 1/10

(57) ABSTRACT

Techniques for calculating or determining risk scores for certain natural disasters perils based on machine learning model outputs are discussed herein. For example, a machine learning model may weight each of the pixels of a map in accordance with the set of weights associated with a structure, to calculate a risk score for a particular natural disaster peril associated with that structure. A plurality of risk selections may be provided to a user computing device for selection by a user, with those risk selections being associated with that risk score. Advantageously, the computing system facilitates the interaction of datasets with different measurement parameters in a machine learning model. In normalizing datasets before providing the datasets to input nodes of a machine learning model, a computing system may efficiently provide hazard and vulnerability outputs of the machine learning model.

### BACKGROUND

Systems and networks utilize data associated with natural disasters, including fires, to perform various types of automated operations and/or to control devices and/or machinery of various types. The natural disaster data is maintained by government systems and/or networks, and/or other types of publicly available systems and/or networks. The systems and networks gather the natural disaster data that includes data captured by sensors associated with various instruments and/or devices. The natural disaster data is provided by various types of sources and/or via various types of communication channels. The natural disaster data is utilized to generate and/or obtain natural disaster incident related information and/or information utilized for various types of basic information about natural disasters. The natural disaster data is used in various industries and for various applications.

Systems and networks process the maintained data, which includes the natural disaster data, and identify natural disaster risk factors. The risk factors are associated with likelihoods of occurrences of natural disasters and are utilized to provide risk assessments associated with various types of natural disasters. Providing the risk assessments can including identifying risk scores in reports that are generated using various types of government and/or publicly available data. The reports are generated utilizing data associated with various regions of land. The reports include information that identifies risk layers for maps of the land regions.

### BRIEF DESCRIPTION OF THE DRAWINGS

FIG. 1 depicts an example network environment for performing hazard and/or vulnerability management utilizing natural disaster shed data.

FIG. 2 depicts example systems for performing hazard and/or vulnerability management utilizing natural disaster shed data.

FIG. 3 depicts an example device for performing hazard and/or vulnerability management utilizing natural disaster shed data.

FIG. 4 depicts an example network environment for performing hazard and/or vulnerability management utilizing natural disaster shed data.

FIG. 5 depicts an example process for performing hazard and/or vulnerability management utilizing natural disaster shed data.

### DETAILED DESCRIPTION

Techniques for utilizing environment indicator data to manage a natural disaster related characteristic model are discussed herein. For example, the environment indicator data can include the natural disaster shed data and/or other environment indicator data. The natural disaster shed data can include fire shed data. The fire shed data can identify fire sheds. The fire shed data can be identified based on topography region data, which can include fire behavior data, fire topography data, water shed data (e.g., data associated with water sheds), any other type of topography region data, or any combination thereof. The other environment indicator data can include environment overrun data and/or environment inundation data. The environment overrun data and the environment inundation data can include fire overrun data and fire inundation data, which can be identified based on water overrun data and water inundation data, respectively. The environment indicator data can be input to a machine learning (ML) model, which can include the natural disaster related characteristic model. The natural disaster related characteristic model can include a hazard, vulnerability, and/or other natural disaster related characteristic model, which can include a hazard and/or vulnerability model. The natural disaster related characteristic model can generate an output, including a hazard, vulnerability, and/or other natural disaster related characteristic output. The hazard, vulnerability, and/or other natural disaster related characteristic output can be utilized to determine recommendation information.

The environment indicator data can include various types of environment indicator data, including the environment shed data and/or the other environment indicator data. The natural disaster shed data can include the fire shed data, which can be generated using the water shed data. The fire shed data can identify fire sheds associated with topography regions, which be identified by the water shed data. The fire shed data can be generated by redefining, reidentifying, converting, and/or modifying the water shed data to be the fire shed data. The other environment indicator data can include overrun data (or “flood data”), which can include the natural disaster overrun data and inundation data, which can include the natural disaster inundation data. The natural disaster overrun data and the natural disaster inundation data can include the fire overrun data and the fire inundation data, respectively. The fire overrun data and the fire inundation data can be generated by redefining, reidentifying, converting, and/or modifying the water overrun data and the water inundation data to be the fire overrun data and the fire inundation data, respectively.

The ML model, which can include the natural disaster related characteristic model, can include any of various types and/or any of various combinations of ML models. For example, the ML models can include an ensemble model or any of other ML models of other types. The ensemble model can include any number and/or any combination of the other ML models. The other ML models can include an ML neural network model (or “neural network model), an ML deep learning model (or “deep learning model”), an ML decision tree model (or “decision tree model”), and/or various other ML models of various types. The natural disaster related characteristic model can include any number and/or any combination of natural disaster related characteristic models, which can include a hazard model, a vulnerability model, and/or any number and/or any combination of various types of other natural disaster related characteristic models. Any of the types and/or any of the combinations of the ML models can include the hazard model, the vulnerability model, any of the other natural disaster related characteristic models, or any combination thereof.

The output of the natural disaster related characteristic model can be utilized to perform various types of actions. The actions performed utilizing the hazard, vulnerability, and/or other natural disaster related characteristic model output can include determining, outputting, and/or transmitting recommendation information (e.g., “home hardening” recommendation information), and/or other actions. The other actions can include controlling machinery for product shipments and/or deliveries, performing automated remedial and/or preventative operations, and/or various other types of actions. The recommendation information can include risk mitigation activity information. The risk mitigation activity information can identify any of various risk mitigation activities utilized as protection from, and/or prevention, mitigation, avoidance, and/or rerouting of natural disasters, including fires (e.g., wildfires).

Utilizing the environment indicator data based natural disaster related characteristic model, has many technical benefits. The environment indicator data, which can include the natural disaster shed data, the natural disaster overrun data, the natural disaster inundation data, and/or the other environment indicator data, can include customized, filtered, selective, targeted, and/or refined data, which can include proprietary data (e.g., non-public data). The data, being customized, filtered, selective, targeted, and/or refined, and possibly including proprietary data, can increase accuracy, efficiency, quality, and/or applicability of the natural disaster related characteristic model output. By increasing the accuracy, the efficiency, the quality, and/or the applicability of the natural disaster related characteristic model output, compute resources of devices and/or systems utilized to perform operations to generate the natural disaster related characteristic model output can be conserved in contrast to existing devices and/or systems.

The devices and the systems being implemented according to the techniques discussed herein, which optimize processes utilized to obtain data for generating the natural disaster related characteristic model output, conserve compute resources in contrast to the existing devices and systems. The natural disaster related characteristic model output that is generated using the natural disaster shed data, the natural disaster overrun data, the natural disaster inundation data, and/or the other environment indicator data does not require processing of unnecessary data to be performed as in conventional systems. Any data that may be obtained according to existing technology is not tailored and/or capable of being utilized to effectively identify environment indicator data. Because the conventional systems only have access to vast amounts of disparate, uncoordinated, scattered, and geographically separated data that is unnecessary, unhelpful, and insufficient for enabling analysis to be performed to identify any types of natural disaster data, the conventional systems, which do not utilize environment indicator data that includes the fire shed data, expend large amounts of unnecessary compute resources.

Devices and systems performing natural disaster based operations according to conventional technology utilize various types of environment data, such as publicly available environment data for various purposes, such as to identify probabilities associated with potential future occurrences of natural disasters. While existing systems analyze the publicly available data for the various purposes, such as performing risk analysis with respect to the potential future natural disaster occurrence probabilities, the existing systems do not receive input of environment indicator data, including fire shed data, and are unable to produce a natural disaster characteristic model output, including a fire shed based hazard and/or vulnerability model output.

Compute resources of the devices and/or systems utilizing the techniques discussed herein are optimized in contrast to the existing systems that exchange the various types of environment data. Compute resources of devices and/or systems utilizing conventional technology, which inefficiently and ineffectively analyze existing types of natural disaster data, including miscellaneous unfiltered, and publicly available natural disaster historical data, are unnecessarily consumed. By obtaining and utilizing the customized, filtered, selective, targeted, and/or refined data, possibly including proprietary data, related to the natural disaster indicators, including fire sheds, the devices and/or systems being implemented according to the techniques discussed herein can reallocate compute resources being conserved thereby, to be utilized for performing other tasks.

Compute resources of user devices being operated according to the techniques discussed herein can be conserved in contrast to compute resources of existing user devices. Various types of information being processed by existing user devices is obtained and utilized to perform operations based on the user devices accessing numerous applications and/or executing numerous programs to receive the information which is generated according to conventional technology based on environment data. The environment data that is retrievable by the existing user devices includes publicly available data, including historical data that identifies past natural disasters. The environment data, which is strewn across numerous and disconnected devices and systems, and which is difficult to aggregate and analyze, is utilized for the various operations, such as to provide probabilities of potential future natural disaster occurrences. The operations of existing environment data management systems include providing, to the existing user devices, risk assessments associated with the probabilities of potential future natural disaster occurrences.

The user devices being operated according to the techniques discussed herein obtain real-time, accurate, and efficient information that is generated utilizing the fire shed based hazard and/or vulnerability model output. The user devices being implemented according to techniques discussed herein quickly and efficiently obtain accurate information, including information based on the fire shed based hazard and/or vulnerability model output, thereby conserving utilization of compute resources in contrast to the user devices implemented according to conventional techniques. Moreover, the information being retrieved by the user devices according to the techniques discussed herein includes up-to-date information being refreshed, restored, and/or updated in real-time, thereby avoiding consumption of compute resources that would otherwise be required by existing environment data management systems utilizing large collections of historical information.

Memory resources associated with the devices and systems performing operations associated with the natural disaster related characteristic model are conserved in contrast to existing devices and systems. The devices and systems being implemented according to the techniques discussed herein store customized and refined data that is applicable to determining recommendation information based on natural disaster related characteristic model output, which includes fire shed based hazard and/or vulnerability model output. Existing devices and systems, which store large amounts of publicly available data, including vast collections of historical data, utilize large amounts of memory resources. By processing environment indicator data, which includes fire shed data, the devices and systems being implemented according to the techniques discussed herein conserve memory resources in contrast to the existing devices and systems, which are unable to be utilized to obtain fire shed based hazard and/or vulnerability model output.

Network resources are conserved by utilizing the environment indicator data to manage a natural disaster related characteristic model according to the techniques discussed herein, in contrast to conventional techniques that merely collect and store historic environment data, including publicly available historic natural disaster data. Numbers and sizes of communications being exchanged between the devices and systems managing the natural disaster related characteristic model and the user devices according to the techniques discussed herein, are greatly reduced in contrast to the communications being exchanged according to conventional technology. Existing devices and systems exchange vast amounts of large sized communications with existing user devices to obtain and analyze data for purposes of collecting and storing historic natural disaster data, in contrast to devices and systems operating according to the techniques discussed herein, which efficiently and effectively exchange recommendation information communications with client devices based on hazard and/or vulnerability model output being generated utilizing fire shed data.

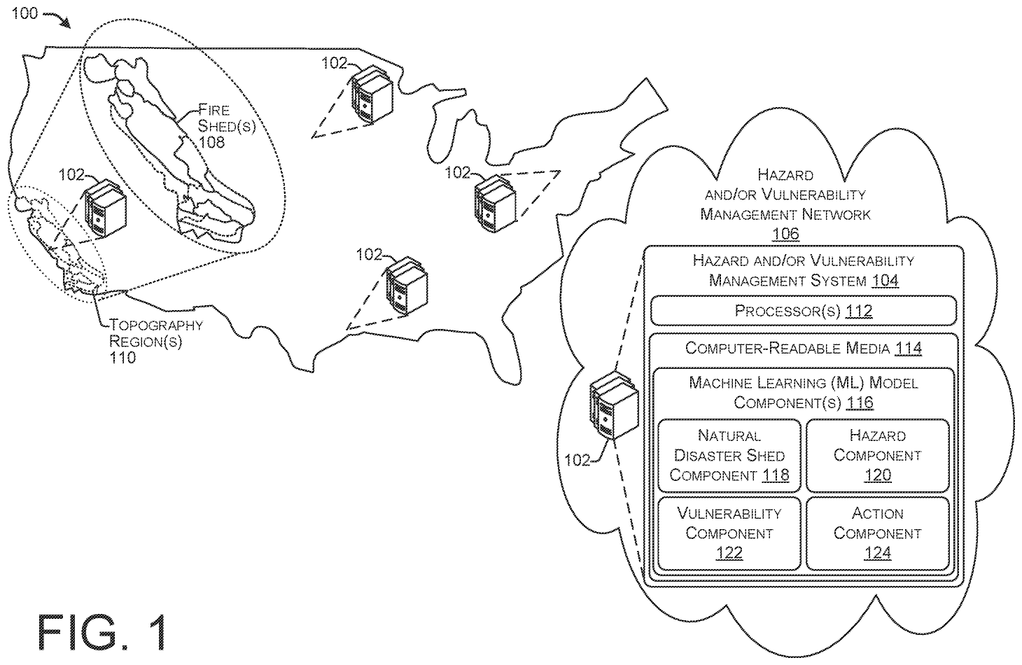

FIG. 1 depicts an example network environment 100 for performing hazard and/or vulnerability management utilizing natural disaster shed data. The environment 100 can include one or more computing systems 102 in one or more networks. Individual ones of the computing system(s) 102 can include a hazard and/or vulnerability management system 104. Individual ones of the network(s) can include a hazard and/or vulnerability network 106. The computing system(s) 102 can be utilized to identify, determine, generate, manage, and/or modify environment indicator data based on other types of environment indicator data. The environment indicator data can include fire shed data (or “fireshed data”) (or “fire zone data”) associated with one or more fire sheds (or “fireshed(s)”) 108. For example, the fire shed data can include (e.g., identify) the fire shed(s) 108, and/or data associated with the fire shed(s) 108.

In various examples, the fire shed data can be managed in various ways based on the environment indicator data. The environment indicator data can include topology data. The environment indicator data and/or the topology data can include topography data. For example, the topography data can include topography region data. The computing system(s) 102 can be utilized to identify, determine, generate, manage, and/or modify the topography region data. In some examples, the topography region data can include various types of topography region data, such as water shed data (or “watershed data”) (or “water zone data”) (or “catchment area data”) (or “drainage area data”). In various cases, the fire shed data can be managed based on the topography region data, which can include the water shed data.

The topography region data can include (e.g., identify) one or more topography regions 110, and/or data associated with the topography region(s) 110. In some examples, the topography region(s) 110, any of which can include a fire behavior region, can be utilized to identify the fire sheds 108. For instance, the topography region(s) 110 can include one or more water sheds (or “watershed(s)”) (or “catchment areas”) (or “drainage areas”) of the water shed data. In various cases, the fire shed(s) 108 can be identified, determined, generated, managed, and/or modified based on the topography region(s) 110, which can include the water shed(s).

Although the topography region data can be utilized to identify the fire shed data, as discussed above in the current disclosure, it is not limited as such. In various examples, the fire shed data can be generated based on any of one or more types of topography region data, including the topography region data associated with fire behavior. For example, any of the topography region data can include fire behavior data based on various types of data, such as wind data, topography data, and/or any of one or more other types of data associated with, and/or utilized to identify, fire behavior. In various cases, the fire shed data can be generated based on various types of data (e.g., proprietary data). For instance, the fire shed data can be generated based on one or more types of data in the fire behavior data.

Although the topography region(s) 110, which can include the water shed(s), can be utilized to identify the fire shed(s) 108, as discussed above in the current disclosure, it is not limited as such. In alternative or additional examples, the topography region(s) 110 can include any of one or more other types of regions being utilized to identify the fire shed(s) 108. For instance, individual ones of the topography region(s) 110 can include one or more corresponding fire behavior regions utilized to identify corresponding fire shed(s) 108.

The computing system(s) 102 can manage one or more datasets of a group of datasets. Individual ones of the datasets can include any type of data from among various types of the environment indicator data (or “natural disaster indicator data”). In various example, the environment indicator data and/or the topology data can include environment shed data (also referred to herein simply as “shed data” or “zone data”) and/or other environment indicator data. The environment shed data can include the fire shed data and/or the topography region data. The fire shed data can be generated by redefining, reidentifying, converting, and/or modifying the topography region data to be the fire shed data. Alternatively or additionally, the fire shed(s) 108 can be generated by redefining, reidentifying, converting, and/or modifying the topography region(s) 110 to be the fire shed(s) 108.

In some examples, the fired shed data can be utilized to identify, and/or can include a fire oriented hazard zone. In those or other examples, the fired shed data can be utilized to identify, and/or can not include a non-fire oriented hazard zone (e.g., a non-fire oriented hazard zone in the environment indicator data). In those or other examples, a first geographical area associated with at least one fire oriented hazard zone may be indicated in the fire shed data (e.g., the at least one fire oriented hazard zone being identified based on at least one non-fire oriented hazard zone in at least one set of environment indicator data); and/or the at least one non-fire oriented hazard zone may be in the second geographical area (e.g., the second geographical area being represented by at least one set of environment indicator data, the second geographical area possibly overlapping the first geographical area).

The fire shed data can identify one or more areas of land and/or one or more landscapes as the fire shed(s) 108. The fire shed data can identify one or more boundaries associated with the area(s) and/or the landscape(s) as one or more boundaries of the fire shed(s) 108. The fire shed data can identify the area(s) and/or the landscape(s) based on one or more areas of land and/or one or more landscapes, respectively, identified as the topography region(s) 110. The area(s) of land and/or the landscape(s) identified as the topography region(s) 110 can be redefined, reidentified, converted, and/or modified as the area(s) of land and/or the landscape(s), respectively, identified as the fire shed(s) 108. The area(s) of land and/or the landscape(s) identified as the topography region(s) 110 can include at least one area (e.g., a water network) (e.g., a stream network) of the area(s) of land and/or the landscape(s) that drain to one or more portions of the land. The topography region data can identify one or more boundaries associated with the area(s) and/or the landscape(s) as boundaries of the topography region(s) 110.

Individual ones of the area(s), the landscape(s), and the boundary(ies) associated with any of the natural disaster shed data can be associated with and/or identified by any type of location data. The location data can include latitude/longitude coordinates (e.g., global position system (GPS) coordinates), universal transverse Mercator (UTM) coordinates, and/or any other types of location data associated with any of at least one portion of the area(s), the landscape(s), and/or the boundary(ies).

The other environment indicator data can include natural disaster overrun data (also referred to herein simply as “overrun data”) and/or natural disaster inundation data (also referred to herein simply as “inundation data”). The natural disaster overrun data and/or the natural disaster inundation data can include fire overrun data and/or fire inundation data, respectively. The natural disaster overrun data and the natural disaster inundation data can include water overrun data (or “flood data”) and/or water inundation data, respectively. The fire overrun data and/or the fire inundation data can be generated by redefining, reidentifying, converting, and/or modifying the water overrun data and/or the water inundation data to be the fire overrun data and/or the fire inundation data, respectively.

The natural disaster overrun data and/or the natural disaster inundation data can identify overrun areas, land, and/or boundaries and/or inundation areas, land, and/or boundaries. Any of the natural disaster overrun data (e.g., the fire overrun data) (e.g., the water overrun data) can identify one or more areas of land, one or more landscapes, and/or one or more boundaries associated with the area(s) and/or the landscape(s). Any of the natural disaster inundation data (e.g., the fire inundation data) (e.g., the water inundation data) can identify one or more areas of land, one or more landscapes, and/or one or more boundaries associated with the area(s) and/or the landscape(s).

Individual ones of the area(s), the landscape(s), and the boundary(ies) associated with any of the natural disaster overrun data and/or the natural disaster inundation data can be associated with and/or identified by any type of location data. The location data can include latitude/longitude coordinates (e.g., GPS coordinates), UTM coordinates, and/or any other types of location data associated with any of at least one portion of portion of the area(s), the landscape(s), and/or the boundary(ies).

The other environment indicator data can include structure data, natural disaster risk indicator data, property characteristics data, weather data, vegetation data, and/or socio-economic data. In some examples, the structure data can include data associated with one or more structures (e.g., one or more physical structures) (e.g., a residential home (e.g., a single-family residence (SFR)), a duplex, an apartment complex, a condominium structure, a mobile home unit, a commercial structure, an agricultural structure (e.g., a silo or barn), an industrial structure, or any combination thereof). In those or other examples, the structure data can include data received from one or more devices (or “structure related devices”) (e.g., one or more internet of things (IoT) devices) at the structure(s) that provide measurements of environment conditions (e.g., temperature, wind speed, one or more other weather conditions, or any combination thereof) around the structure(s).

Although the structure related device(s) can be utilized to capture data associated with the structure(s), as discussed above in the current disclosure, it is not limited as such. In some examples, the structure related device(s) can include one or more devices of any type related to the structure(s), one or more properties, one or more parcels, any other types of land and/or structure, or any combination thereof. In those or other examples, the structure related device(s) can include one or more property related devices and/or one or more parcel related devices.

In some cases, the structure related device(s) can include one or more communication devices. For example, the structure related device(s) can include one or more wireless devices (e.g., one or more cellular devices) (e.g., an intelligent assistant, a smarthome hub, etc., utilized to provide structure data to the hazard and/or vulnerability management system 104). In the example, the smarthome hub or a wireless computing device can obtain data (e.g., data identifying one or more sizes of one or more portions of structure, one or more physical maintenance activities at the structure, one or more photos of the structure, any other type of structure data, or any combination thereof) regarding the structure.

In various implementations, the dataset(s) (e.g., any of the environment indicator data (e.g., any of the natural disaster risk indicator data)) can include data received from one or more natural disaster data sources (e.g., one or more proprietary data sources (or “privately owned data source(s)”)) (or “disparate data source devices”) (e.g., one or more government-affiliated property assessor devices (e.g., a device of a county property assessor)). In some examples, the property characteristic data includes data that is associated with, and/or that identifies, one or more properties (e.g., one or more physical properties associated with, and/or including, the structure(s)) of the land(s) and/or the landscape(s). In those or other examples, the property characteristic data can be received by the structure related device(s), the natural disaster data source(s), or any combination thereof. In various implementations, individual ones of the natural disaster data source(s) can include a smartphone, a satellite, a weather station, a ground sensor, a satellite receiver, a laptop, a drone, or any other type of natural disaster data source.

In some examples, the structure related devices and/or the natural disaster data source(s) can be communicatively coupled to the hazard and/or vulnerability management system 104 via one or more communications networks (e.g., the hazard and/or vulnerability management network 106). Individual ones of the communication network(s) can include a wired network, a wireless network, or a combination thereof.

In some examples, individual ones of the dataset(s) can be associated with one or more regions (e.g., at least one region associated with and/or including the structure, the property, etc.) of the land(s) and/or the landscape(s). Individual ones of the dataset(s) received from any of the natural disaster data source(s) can be the same as or different from any other of the dataset(s). As an example, a dataset received from a natural disaster data source can include one or more spatial layers (e.g., a spatial layer of a geographic information system (GIS) map). The spatial layer(s) can be included in one or more raster image files.

In various implementations, individual ones of the spatial layers can include at least one of the dataset(s) (e.g., one or more of various types of data). For examples, data (e.g., the dataset(s)) associated with a spatial layer can include ecoregion data (e.g., data indicative of an ecoregion (e.g., a terrestrial ecoregion or biome as defined by the World Wildlife Foundation (WWF)), soils data, atmospheric data, elevation data, property inspection data (e.g., data identifying whether a percentage of a building that was destroyed/damaged) (e.g., data identifying whether any of one or more natural disasters affected the property (ies)), weather index data, various fire risk data (e.g., data identifying an ignition risk associated with the property (ies), the structure(s), etc., based on a fire risk GIS model), historical data (e.g., particular historical data associated with a historical natural disaster that affected the property, the structure, etc.), parcel boundary data, historical flame length data, historical flame intensity data, fire risk model data, historical fire data, moisture data, water data, fire frequency data, any other type of data, or any combination thereof.

In some cases, the dataset(s) (e.g., any of the environment indicator data) (e.g., the data of at least one of the spatial layers of one or more GIS maps) can be identified, determined, received, managed, and/or modified with a temporal resolution. For example, individual ones of the dataset(s) can be associated with a timepoint (e.g., a timepoint (e.g., a period of time) at which the dataset(s) are periodically identified, determined, received, managed, and/or modified) (e.g., 1 second, 1 minute, 1 hour, 1 day, 1 month, 1 year, 1 decade, or any other time period). In some cases, the datasets can be obtained from one or more GIS systems to provide the spatial layer(s) of individual ones of one or more GIS maps to the hazard and/or vulnerability management system 104. For examples, the spatial layer(s) of the GIS map(s) can be provided to the hazard and/or vulnerability management system 104 based on individual ones of the layer(s) having one or more resolutions (e.g., a spatial resolution, a temporal resolution, etc., or any combination thereof).

In various cases, individual ones of the GIS map(s) can include data representative of a region that includes a structure (e.g., any of the structure(s)) and/or a property (e.g., any of the property (ies)). For example, data in a GIS map can include pixel level data of a parcel (e.g., a partial portion or an entire portion of the property with the structure) (e.g., a portion of the land that includes the property) on which the structure resides. The data in the GIS map(s) can include a region of land (e.g., Los Angeles, Orange County, California, or any other region of any type) associated with the structure. In some examples, any of the spatial layers of the GIS map(s) can have any spatial resolution (e.g., a spatial resolution of 2.5 kilometers (km), with one pixel being representative of a 2.5 km level resolution) (e.g., any other spatial resolution of 1 meter (m), 5 m, 10 m, 30 m, 50 m, 500 m, 1 km, 2.5 km, 5 km, 10 km, 100 km, 1000 km, etc.).

In some instances, the natural disaster risk indicator data received from the natural disaster data source(s) can include parcel data, which can include the dataset(s) received from the natural disaster data source(s). In those or other instances, the parcel data can include the spatial layer(s). In those or other instances, individual ones of the spatial layer(s), which can be included in the parcel data, can have the spatial resolution(s) (also referred to herein as “parcel resolution”).

In some examples, the property (ies) identified by the property characteristics data, which can be associated with the structure(s), can surround and/or include the structure(s) (e.g., a property and/or a structure can be defined in parcel information for the structure). In those or other examples, individual ones of the property (ies) (e.g., the property (ies), which are identified by the property characteristics data) can include one or more physical structures or not include the physical structure(s). In some implementations, the structure data can include a portion (e.g., a partial portion or an entire portion) of the property characteristics data. Additionally or alternatively, the property characteristics data can include a portion (e.g., a partial portion or an entire portion) of the structure data.

In some examples, individual ones of the hazard and/or vulnerability management systems 104 can include one or more processors 112 and one or more computer-readable media (e.g., one or more non-transitory computer-readable media) 114. The processor(s) 112 can be utilized to perform one or more operations, and/or to execute one or more instructions stored in the computer-readable media 114 (e.g., one or more executable instructions stored in any of at least one of the component(s) of the computer-readable media 114). The computer-readable media 114 can include one or more components, which can include one or more model components. The model component(s) can be utilized to manage one or more models. For instance, the model(s) can include a model that outputs a home vulnerability score, a model that outputs a hazard score, and/or a model that outputs a hazard and vulnerability score. The model that outputs the home vulnerability score can be referred to as a “home vulnerability model.” The model that outputs the hazard score can be referred to as a “hazard model.” The model that outputs the hazard and vulnerability score can be referred to as a “hazard and vulnerability model.”

In various examples, the model(s) can include one or more ML models. The model component(s) can include one or more machine learning (ML) model components 116. The ML model component(s) 116 can be utilized to manage the ML model(s).

The executable instructions can be encoded on a memory and can include both non-transitory computer storage media and communication media. The non-transitory computer storage media and/or communication media can include any medium that facilitates transfer of a computer program (e.g., a set of executable instructions) from one place to another.

In some implementations, the ML model(s) being managed by the ML model component(s) 116 can include one or more natural disaster related characteristic models. Any of various types and/or any of various combinations of the ML models being managed by the ML model component(s) 116 can include the natural disaster related characteristic model. The ML models being managed by the ML model component(s) 116 can include an ensemble model or any of other ML models of other types. The ensemble model can include any number and/or any combination of the other ML models. The other ML models can include a neural network (e.g., a fully convolutional network (e.g., a network utilizing a u-net architecture), a convolutional neural network (CNN), etc.), a deep learning model, a decision tree model, and/or various other ML models of various types.

In various examples, any of the ML models can be utilized by the ML model component(s) 116 based on classifier data, which can include one or more classifiers. Individual ones of the classifier(s) can be identified, determined generated, assigned, modified, etc., to any of the ML models. Individual ones of the ML models can be utilized by the ML model component(s) 116 for any of at least one of the dataset(s).

In some cases, a first type of ML model can be utilized for a first dataset (e.g., a first dataset being utilized as a training dataset) of a first type (e.g., a dataset that includes at least one type of data (e.g., a portion of the structure data, a portion of the vegetation data, etc.), at least one location of at least one structure, at least one location of at least one property, etc., or any combination thereof). The first type of ML model can be utilized for the training dataset based on a level of accuracy resulting from the first type of ML model, with respect to identifying a hazard score, a vulnerability score (or “home vulnerability score”), or a combination thereof (e.g., a hazard and vulnerability score), as discussed below in greater detail, being greater than a different level of accuracy result from a second type of ML model. A classifier may be assigned to the first type of ML model (e.g., the ensemble model) and/or for the training dataset, the classifier being different from a second classifier assigned to another type of ML model (e.g., the neural network based ML model, the decision tree (e.g., a) based ML model, etc.) and/or another training dataset based on a level of prediction accuracy associated with the first type of ML model and/or the training dataset being greater than for the second type of ML model and/or the other training dataset.

For example, different ML techniques can be used on various different sets of training datasets to determine to utilize any of the training datasets, or any combination thereof, to train the train any of the ML model(s). The types of ML model(s) can be used to classify individual ones of the datasets to have a level of prediction accuracy. A voting mechanism and/or count can be utilized to identify the classifier(s) to indicate a desired prediction accuracy level (e.g., the ML model(s) can be utilized to predict classifiers for corresponding datasets, based on the training). Upon receiving a second dataset, the classifier(s) can be utilized to identify, by determining similarities between the second dataset and the training dataset, a level of prediction accuracy associated with the second dataset.

In various cases, the natural disaster related characteristic model(s) can include any number and/or any combination of natural disaster related characteristic model(s), which can include the hazard model, the vulnerability model, the hazard and vulnerability model, as discussed below in greater detail, and/or any number and/or any combination of various types of one or more other natural disaster related characteristic models. Any of the types and/or any of the combinations of the ML models can include the hazard model, the vulnerability model, any of the other natural disaster characteristic model(s), or any combination thereof.

In various cases, the hazard model, the vulnerability model, and/or the hazard and vulnerability model can be trained utilizing the training datasets to generate, based on the classifier(s), corresponding output. For example, the hazard output, the vulnerability model, and/or the hazard and vulnerability output can be based on the training of the hazard model, the vulnerability model, and/or the hazard and vulnerability model, respectively, using the training datasets, and further based on the classifier(s).

In various implementations, the classifier(s) can be utilized to utilize any of the model(s) (e.g., the hazard model, the vulnerability model, and/or the hazard and vulnerability model) for any of the dataset(s). For example, the hazard and/or vulnerability management system 104 can train the ML model(s) in the ML model component(s) 116 to utilize the hazard model (e.g., but not the vulnerability model) to analyze a dataset (e.g., a dataset with property characteristics data), the vulnerability model (e.g., but not the hazard model) to analyze another dataset (e.g., a dataset with structure data), and the hazard and vulnerability model to analyze yet another dataset (e.g., a dataset with property data and structure data).

In some cases, the ML model component(s) 116 can include an environment indicator component (e.g., a natural disaster shed component (or “shed component”)) 118, a hazard component 120, a vulnerability component 122, and/or an action component 124. In some examples, the environment indicator component (e.g., the natural disaster shed component) 118 can be utilized to identify, determine, capture, manage, and/or modify the environment indicator data (e.g., the shed data, the other environment indicator data).

In various implementations, the hazard component 120 can be utilized to identify, determine, generate, manage, and/or modify the hazard model and/or hazard information (e.g., information output by the hazard model). In some examples, the hazard information can include a hazard score. The hazard score may be indicative of a wildfire peril to the structure based on a type of wildfire with which the wildfire peril is associated.

For example, the hazard score may be indicative of a probability that the wildfire may affect a structure. In some cases, a relatively greater hazard score may correspond to a relatively greater likelihood that a type of wildfire (e.g., the type of wildfire with which the wildfire peril is associated) may affect a structure, in comparison to another hazard score (e.g., a relatively lower hazard score) that corresponds to a relatively lower likelihood that any of one or more other types of wildfires may affect a structure.

In some cases, the hazard score can be computed by the hazard component 120 based on input data (e.g., the natural disaster shed data (e.g., fire shed data), the natural disaster data (e.g., natural disaster risk indicator data), the vegetation data, the structure data, the property the characteristic data, and/or the weather data.

In some cases, the vulnerability score can be computed by the vulnerability component 122 based on input data (e.g., the natural disaster shed data (e.g., fire shed data), the natural disaster data (e.g., natural disaster risk indicator data), the vegetation data, the structure data, the property the characteristic data, and/or the weather data. For example, a vulnerability output (e.g., the vulnerability score) can include a set of weights associated with the structure and/or the property. The vulnerability score can be determined based on the label(s) (e.g., data, as discussed in further detail below, indicative of various risks associated with the physical structure or the property, such as vegetation, hazard mitigation components, and/or historical structure information (e.g., historical loss information for that structure)).

As an example, a hazard score and/or a vulnerability score associated with an area (e.g., a property and/or a structure in, and/or within a threshold distance from, a fire shed) and a possibility of a wildfire may be relatively greater than another hazard score and/or another vulnerability score, respectively. Any of the score(s) for another area may be relatively greater based on no other wildfire being in the other area (e.g., another property and/or structure not in, and not within a threshold distance from, a fire shed). The relatively greater hazard score hazard and/or the relatively greater vulnerability score may be based on, for instance, the area being a distance from the fire shed that is less than the threshold distance, and/or based on the area associated with the fire shed being identified as having a greater likelihood of a wildfire than the area not associated with the fire shed.

As another example, a hazard score and/or a vulnerability score for a structure being determined based on a possibility of a type of wildfire including a wildfire without embers, may be relatively lower than another hazard score and/or another vulnerability score as pertaining another possibility of a type of wildfire including a wildfire with embers. The relatively lower hazard score and/or the relatively lower vulnerability score may be based on, for instance, installations on the structure of materials protecting the structure from embers.

As another example, a hazard score and/or a vulnerability score being determined for an area (e.g., a structure, a property, etc.) based on a possibility of a type of wildfire including a brush fire within a threshold distance from a structure may be relatively greater than another hazard score and/or a vulnerability score for a different area based on another possibility of another type of wildfire including a wind-driven fire or a canopy fire. The relatively greater hazard score and/or the relatively greater vulnerability score may be based on, for instance, the structure being surrounded by brush (e.g., a presence of brush as indicated by the vegetation data) that causes the structure to be relatively more susceptible to the brush fire, in comparison to the wind-driven fire or the canopy fire.

In various implementations, the vulnerability component 122 can be utilized to identify, determine, generate, manage, and/or modify the vulnerability model and/or the vulnerability information (e.g., information output by the vulnerability model). In those or other examples, the action component 124 can be utilized to identify, determine, generate, manage, and/or modify the action information (e.g., information associated with one or more actions based on output of the natural disaster related characteristic model(s)).

The hazard score and/or the vulnerability score can be identified as corresponding risk scores associated with a hazard and a vulnerability. In contrast to a risk score determined by existing systems and that merely indicates, based on historical data, a possibility of a future occurrence of a natural disaster (e.g., a wildfire) (e.g., an existence or a nonexistence of a possibility of the occurrence of the wildfire), the hazard score and/or vulnerability score determined according to the techniques discussed herein can include the hazard score, which includes a likelihood (e.g., a statistical likelihood) that a wildfire may affect a property and/or a structure.

In some examples, the hazard score can be identified as a likelihood (e.g., a statistical likelihood) (e.g., a destruction likelihood) of a type of natural disaster (e.g., a wildfire) being a hazard to an area (e.g., the wildfire causing a portion of a structure and/or a property to be “lost,” including being damaged, destroyed, etc.). In those or other examples, the vulnerability score can be identified as a score corresponding to a level of vulnerability of an area (e.g., a structure and/or property) to a type of natural disaster (e.g., a wildfire).

In some examples, the hazard score and/or the vulnerability score can be generated based on, and/or taking into account, the probability of the occurrence of the natural disaster (e.g., the probability of the occurrence of the natural disaster in an area). Alternatively, the hazard score and/or the vulnerability score can be generated regardless (e.g., partially or entirely regardless) of the probability of the occurrence of the natural disaster. For example, the hazard score and/or the vulnerability score can be determined as being the output of the hazard and/or vulnerability model system 216 (e.g., the hazard and/or vulnerability model output can include a likelihood of a hazard to a home based on a material of the home, vegetation around the home, mitigation materials installed at the home, etc.), notwithstanding any other values associated with risks of wildfire occurrences.

For example, the hazard and/or the vulnerability score can be generated by “assuming,” for a type of fire hazard, that a fire may occur anywhere. However, in contrast to existing systems that merely look at probabilities of occurrences of natural disasters, the system(s) (e.g., the hazard and/or vulnerability model system 216) according to the techniques discussed herein can generate the hazard and/or the vulnerability score, based on the dataset(s), which identify data associated with differences (e.g., one or more different characteristics) between different types of fires. The hazard and/or vulnerability model system 216 can identify one or more metrics based on the input data, and by using the hazard and/or the vulnerability score. For example, the metric(s) may be associated with a likelihood (e.g., a statistical likelihood) of a portion of a structure (e.g., as identified by a pixel) being lost due to a catastrophic event (e.g., a wildfire), based on the hazard score (e.g., which can be utilized to identify a predicted monetary loss).

In various implementations, the ML model component(s) 116 can utilize sensor data and/or map data to generate ML model output (or “hazard and/or vulnerability output”), which can include ML model output information. In some cases, the ML model output information can include hazard and/or vulnerability output information.

In some examples, the sensor data can include image data (e.g., current data being dynamically captured in real-time by one or more image devices (e.g., one or more cameras)). In those or other examples, the map data can include stored data (e.g., previously captured and/or previously stored data) associated with one or more maps of the land(s) and/or the landscape(s). In those or other examples, the sensor data (e.g., the image data) can be combined with the map data as combined data, which can include updated map data that is stored as the map data. The map data, for example, can include one or more pixels (e.g., one or more image pixels) associated with one or more portions of the land(s) and/or the landscaped(s). The combined data can be utilized for any of the techniques discussed herein, in a similar way as for the sensor data and/or the map data.

In some implementations, the ML model component(s) 116 can identify weight data associated with pixel data (e.g., data including the pixel(s)), the weight data identifying one or more weights. The ML model component(s) 116 can identify, determine, generate, manage, assign, and/or modify the pixel(s) and/or the weight(s), individual ones of the pixel(s) being weighted (e.g., assigned a weight). The ML model component(s) 116 can weight individual ones of the pixel(s), any of which can be associated the structure(s) and/or the property (ies). In some examples, weighting of individual ones of the pixel(s) can be based on the environment indicator data (e.g., the shed data, the overrun data, the inundation data, any of the other environment indicator data, or any combination thereof).

In some examples, a relatively lower weight may be associated with a relatively lower level of a natural disaster related characteristic (e.g., a relatively lower weight may be associated with a relatively lower level of a hazard, a relatively lower level of a vulnerability, etc.). In those or other examples, a relatively greater weight may be associated with a relatively greater level of a natural disaster related characteristic (e.g., a relatively greater weight may be associated with a relatively greater level of a hazard, a relatively greater level of a vulnerability, etc.).

In some implementations, the hazard and/or vulnerability output information can include hazard information as output of the hazard component 120 and vulnerability information as output of the vulnerability component 122. In some examples, the hazard and/or vulnerability output information can include the hazard information but not the vulnerability information. In those or other examples, the vulnerability information can be omitted from the ML mode output based on the ML model component(s) 116 refraining from utilizing the vulnerability component 122.

Alternatively, the hazard and/or vulnerability output information can include the hazard information but not the vulnerability information. In those or other examples, the hazard information can be omitted from the ML mode output based on the ML model component(s) 116 refraining from utilizing the hazard component 120.

In various examples, training of the ML model(s) managed by the ML model component(s) 116 can include identifying, determining, capturing, managing, and/or modifying data (or “training data”) (also referred to herein as “label data”) to train the ML model(s), and training the ML model(s) based on the training data. The training data can include any data (e.g., any of the environment data (or “training environment data”), including any of the environment indicator data (or “training environment indicator data”)) that is previously identified, determined, generated, managed, and/or modified.

In various examples, training of the ML model(s) managed by the ML model component(s) 116 can include identifying, determining, generating, managing, and/or modifying information as being included in the training data utilized to train the ML model(s). At least one portion of the training data can be identified based on various types of information (e.g., any of the information output by individual ones of the ML model(s) and/or individual ones of the ML model component(s) 116), including any of the hazard and/or vulnerability information (or “training hazard and/or vulnerability information”)) that is previously identified, determined, generated, managed, and/or modified.

For instance, with examples in which training of the ML model(s) is performed, the ML model(s) are trained utilizing the label data, which can include one or more labels that are stored in a labels memory of the hazard and/or vulnerability management systems 104. The training data (e.g., the label(s)) can be input to the ML model(s) and utilized to training the ML model(s) based on user input. For example, individual ones of the model(s) can be trained based on the label(s) (e.g., a partial portion or an entire portion of the label data) including training data. In such an example or another example, individual ones of the model(s) can be trained based on previous fire shed data, which can be included in, and/or utilized as, the training data. In such an example or another example, individual ones of the model(s) can be trained based on training hazard and/or vulnerability model output, which can be included in, and/or utilized as, the training data. In such an example or another example, individual ones of the model(s) can be trained based on training information that comprises a map defined by a set of pixels, which can be included in, and/or utilized as, the training data. Individual ones of the pixels may be associated with a corresponding hazard and/or vulnerability probability for a particular natural disaster peril associate with a particular region (e.g., California). The training can be based on user input, confirming, modifying, etc., of the training output.

Although the shed component be utilized to manage the shed data, as discussed above in the current application, it is not limited as such. In some examples, the shed component can be utilized to manage the overrun data and/or the inundation data in a similar way as for managing the shed data. In various cases, any of at least one of the shed data, the overrun data, and/or the inundation data can be included as input utilized by the hazard and/or vulnerability management system 104, based on any of at least one other of the shed data, the overrun data, and/or the inundation data being excluded from input utilized by the hazard and/or vulnerability management system 104.

In some cases, the hazard and/or vulnerability model can include a hazard model, a vulnerability model, or a composite model, the composite model including the hazard model, the vulnerability model, and/or any other types of models utilized to generate output utilized to perform one or more actions. In various examples, the natural disaster related characteristic model can generate a hazard, vulnerability, and/or other natural disaster related characteristic output, which can include the hazard score, the vulnerability score, or the composite score. In some instances, the composite score can include the hazard score, the vulnerability score, and/or any other types of scores utilized to perform one or more actions (e.g., any of the action(s) performed by the action component 124).

The action component 124 can perform one or more of various actions of various types. In some examples, the action(s) can include transmitting one or more message(s) to one or more client devices, which can be communicatively coupled to the hazard and/or vulnerability management system 104 via the hazard and/or vulnerability management network 106. The message(s) can be transmitted to the client devices automatically, and in real-time, in response to the ML model component(s) output being identified.

In some cases, at least one of any of one or more operations performed by the hazard and/or vulnerability management system 104 can be performed in response to receiving one or more messages from the client device(s). The received message(s) can include one or more requests for output of the ML model component(s) 116. For example, a client device can receive input from a user and to a user interface (UI) (e.g., a display, a touchscreen, one or more keys, etc.), the input being associated with one or more user selections. The user selection(s) may be associated with the user selecting an operation of the client device to transmit a request to the hazard and/or vulnerability management system 104.

In various cases, the request(s) received from the client device(s) can be utilized by the hazard and/or vulnerability management system 104 to perform the operation(s). In some cases, the operation(s) can include automatically generating output of individual ones of the ML model component(s) (e.g., output of any of the natural disaster shed component 118, the hazard component 120, the vulnerability component 122, the action component 124, or any combination thereof).

For example, a request received from a client device can be utilized by the hazard and/or vulnerability management system 104 to identify a portion of environment indicator data associated with a structure and/or a property identified by the request. The hazard and/or vulnerability management system 104 can, in response to receiving the request, generate at least one of the score(s) (e.g., a hazard and/or vulnerability score) based on the portion of environment indicator data, and transmit the hazard and/or vulnerability score to the client device. The hazard and/or vulnerability score can be generated and/or transmitted automatically and in real-time. For instance, a hazard and/or vulnerability score can be generated and/or transmitted based on a request, without any intervening input to the hazard and/or vulnerability management system 104 and/or the client device.

The action(s) of the hazard and/or vulnerability management system 104 can be performed in response to the action(s) being identified in the message(s) from the client device(s) and/or in response to identifying of the action(s) being performed by the hazard and/or vulnerability management system 104 (e.g., based on the hazard and/or vulnerability management system 104 receiving the request(s). In some cases, individual ones of the action(s) are performed based on corresponding request(s) identifying the action(s). For example, a message requesting a score can be received by the hazard and/or vulnerability management system 104, causing the hazard and/or vulnerability management system 104 to automatically generate and to, possibly, transmit the requested score (e.g., before or after user input to the hazard and/or vulnerability management system 104, the input being associated with a user selection that approves the score).

In another example, a message requesting a score can be received by the hazard and/or vulnerability management system 104, causing the hazard and/or vulnerability management system 104 to automatically identify a score (e.g., a type of score, such as a hazard score). The hazard and/or vulnerability management system 104 can, possibly, generate the hazard score based on the request, and, possibly, transmit the requested hazard score (e.g., before or after user input to the hazard and/or vulnerability management system 104, the input being associated with a user selection that approves the score) based on the request.

The hazard and/or vulnerability management system 104 can cause presentation, by the client device(s) (e.g., by one or more displays of the client device(s)), of information associated with any output of the hazard and/or vulnerability management system 104. For examples, the hazard and/or vulnerability management system 104, based on output being generated (e.g., in response to receiving the request(s) from the client device(s)), can transmit one or more signals that are used, automatically, by the client device(s) to display any information indicating by the signal(s) (e.g., information indicating the output of the hazard and/or vulnerability management system 104).

The message(s) transmitted to the client device(s), via operation of the action component, can include mitigation information. In some examples, the hazard and/or vulnerability management system 104 can transmit, automatically and/or in real-time, the message(s) identifying one or more mitigation actions to the client device(s). The message(s) identifying the mitigation action(s) can be based on the output of the hazard and/or vulnerability management system 104.

In some examples, the mitigation action(s) can include various types of actions to reduce likelihoods of destruction to a structure. For example, the mitigation action(s) can include removing vegetation, installing hardware on the structure and/or property, removing “ladder fuels” near the structure (e.g., live or dead vegetation that allows a fire to spread upwards), changing a material of a roof or siding of the structure, cleaning defensible spaces, roofs, or gutters of dead vegetation and debris from the structure and/or property, using ember protection devices and materials, changing an aspect of the windows of the structure (e.g., changing from single pane to double pane), and/or any other types of mitigation actions, or any combination thereof.

The hazard and/or vulnerability management system 104 can transmit the message(s) identifying information associate with the mitigation action(s) based on the score(s). For example, a mitigation action may include brush removal, based on the vulnerability score indicating vulnerability to brush fires. In such an example, any details associated with the mitigation action can be provided in the message indicating the mitigation action, and/or in one or more separate messages.

The hazard and/or vulnerability management system 104 can initiate one or more communication sessions between a user of the hazard and/or vulnerability management system 104 and a user of the client device. The communication session(s) can be automatically initiated via the message(s) identifying the mitigation action(s), and/or initiated by one or more separate messages based on user input to the hazard and/or vulnerability management system 104 and/or user input to the client device(s).

In some examples, the action(s) performed and/or controlled by the action component 124 can include transmitting, by the hazard and/or vulnerability management system 104, one or more signals causing automated operation of one or more machinery robots, robotic arms, conveyor belts, fulfillment machinery, or any combination thereof. For example, machinery utilized for locating, obtaining, transmitting, packaging, shipping, and/or delivering one or more items, products, packages, etc., can be controlled automatically by the hazard and/or vulnerability management system 104 and/or one or more other systems and/or devices (e.g., via one or more signals exchanged between the hazard and/or vulnerability management system 104, the client device(s), and/or the other system(s) and/or device(s).

Communications can be exchanged automatically with the hazard and/or vulnerability management system 104, the client device(s), and/or one or more other systems and/or one or more other devices in response to the request(s) of the client device(s) and/or the output of the hazard and/or vulnerability management system 104. The communications can include one or more communications between any of the hazard and/or vulnerability management system 104, the client device(s), and/or the other device(s) and/or the other system(s) to request one or more services of one or more persons (e.g., employees) associated with one or more companies with which the other system(s) and/or the other device(s) are associated. The communication with the other system(s) and/or the other device(s) are associated can provide one or more service(s) to perform one or more mitigation actions.

The message(s) transmitted to the client device(s) based on the output of the can be utilized to notify the user(s) of the client device(s) regarding the risk mitigation activity (ies). In some examples, the message(s) can cause one or more notifications identifying one or more activities to be added to one or more electronic “to-do lists” being managed via software executed by the client device. In those or other examples, the notification(s) being utilized to add one or more appointments to one or more electronic calendars being managed via software executed by the client device(s).

Although the topography region data, the shed data, the overrun data, and the inundation data are discussed throughout the disclosure, it is not limited as such. In some examples, any terms including “topography region data,” “shed data,” “overrun data,” and “inundation data” can be referred to, for simplicity and easy of explanation, as different types of “topography region data” and/or “shed data,” such as “topography region data” being a first type of topography region data, “shed data” being a first type of shed data, “overrun data” being a second type of shed data, “inundation data” being a third type of shed data, etc. In some examples, the term “topography region data” and/or “shed data” can be used with reference to any of various different environment types, such as a topography region (e.g., a water shed), a fire shed, any other types of topography region, or any combination thereof.

Although the hazard score and/or the vulnerability score are due to various environment indicator data as discussed throughout the current disclosure, it is not limited as such. In some examples, the socio-economic data, which can include various types of data associated with accessibility to fire stations, availability of fire safety equipment, etc., can be utilized as input data for determining the hazard score and/or the vulnerability score. For example, the hazard score and/or the home vulnerability score can be determined based on various types of data (e.g., a fire crew responsiveness action associated with at least one potential future environment in at least one proximity of at least one property).

Although the hazard score and/or the vulnerability score are determined in various ways as discussed throughout the current disclosure, it is not limited as such. In some examples, at least one of any type of information, as discussed herein, being identified along with, and/or being associated with, the hazard score and/or the vulnerability score, can be interpreted as being included as part of various types of identified information (e.g., hazard information, vulnerability information (e.g., home vulnerability information), or a combination thereof, respectively) that is associated with the hazard score, the vulnerability score, or a combination thereof, respectively.

Although the risk mitigation activity (ies) of various types are determined in various ways as discussed throughout the current disclosure, it is not limited as such. In some examples, at least one of any type of information, as discussed herein, being identified along with, and/or being associated with, the risk mitigation activity (ies), can be interpreted as being included as part of various types of identified information (e.g., risk mitigation activity information (or “risk mitigation information”)) that is associated with the risk mitigation activity (ies).

As a hypothetical example, various types of data, such as wind data and vegetation data associated with topography data can be identified. The topography data can include, and/or be utilized to identify, a topography region 110. The topography data can include data associated with, and/or generated by, individual ones of the computing system(s) 102 associated with corresponding parties (e.g., one or more corresponding third-parties). For instance, wind data can identify types of wind, including wind speed; and vegetation data can include tree data, which can identify types of trees.

In the hypothetical example, the topography data can include other data of any of one or more other types associated with, and/or generated by, one or more other corresponding parties (e.g., one or more other corresponding third-parties). A first set of the other data associated with a first party can include one or more slopes associated with one or more portions of land identified by the topography region(s) 110. A second set of the other data associated with a first party can include one or more occurrences of human activity associated with the topography region(s) 110. A behavior model can be utilized to identify a fire shed 108 based on the topography region 110 for home insurance purposes.

In the hypothetical example, and in contrast to existing systems that do not have access to the proprietary data utilized to identify the fire shed(s) 108, significant information can be generated accurately and efficiently using the fire behavior model generated fire shed(s) 108. The fire behavior model, being customized for home insurance applications, can analyze the topography region(s) 110 and generate the fire shed(s) 108 using various types of data other than publicly available data. By utilizing the various types of data other than publicly available data, analysis of the fire behavior model can be optimized for forest management applications.

In the hypothetical example, a mountain may be identified, which may include steep slopes and a peak with snow cap at the peak. The mountain may include trees on a north side that are similar to trees on a south side. However, because of the peak acting as a “divider,” the north side can be identified as a topography region 110 that is different from a topography region 110 in which the south side is identified. For instance, the sides being similar may include sides of one or more same, and/or a similar, characteristics, including a degree of a slop, a length, a height, a width, and/or one or more other characteristics.

Alternatively or additionally, one or more different types of plant species thriving in different soil types from other plant species, may be utilized to differentiate areas of land. One or more areas of land can be identified and/or bucketed, as the fire shed(s) 108, based on one or more fire behavior regions. The area(s) of land can be identified and/or bucketed based on wildfire resource data. For instance, soil type can be utilized to identify the fire shed(s) 108.

In some examples, one or more areas of land with brown dirt and one or more other areas of land with gravel may be identified. Any of the area(s) of land with the brown dirt can be identified as a topography region 110. Any of the area(s) of land with the gravel can be identified as another topography region 110. The topography region 110 identified based on the area(s) of land with the brown dirt may be different from another topography region 110 identified based on the area(s) of land with the gravel. The topography region 110 that is different from the other topography region 110 can be identified notwithstanding trees in the area(s) of land with the brown dirt being similar to trees in the area(s) of land with the gravel. For instance, trees being similar may include trees of one or more same, and/or a similar, characteristics, which may include a genus, a species, a type, an age, a color, a height, a size, a diameter, and/or one or more other characteristics. The trees in the brown dirt may have moisture content levels than the trees in the gravel, for example, due to the brown dirt enabling more efficient and effective water extraction by the trees in the brown dirt.

The fire shed(s) 108 can be identified as including different fire shed(s) 108 associated with the different topography region(s) 110. For example, the fire shed(s) 108 being generated can be based on fire behavior. Individual ones of the fire shed(s) 108 being generated can be associated with the relatively more moderate slope and/or the brown dirt. The fire behavior includes fires that are relatively less likely to be strong, ignited, quick to spread, etc., in the areas associated with the relatively more moderate slope and/or the brown dirt. Individual ones of the fire shed(s) 108 being generated can be associated with a relatively less moderate slope and/or the gravel. The fire behavior includes fires that are relatively more likely to be strong, ignited, quick to spread, etc., in the areas associated with the relatively steeper slope and/or the gravel.

Although various types of data, including proprietary data, can be utilized to identify the fire shed data, as discussed above in the current disclosure, it is not limited as such. In some examples, various types of data, including one or more other types of data, which may or may not include proprietary data, can be utilized to identify the fire shed data. In various examples, the fire shed(s) 108 can be identified as one or more corresponding areas of the land, based on one or more of various types of data. The corresponding area(s) of the land can include one or more areas associated with the topography region(s) 110 where fire behaves in certain ways.

In some examples, environmental factors data can identify one or more environmental factors with which the various type(s) of topology data (e.g., topology region data) can be utilized to generate the fire shed(s) 108 are associated. The environmental factors data can be utilized to identify any of the environment indicator data. The environmental factor data can include the vegetation data, which can include species data and/or growth data. For example, the species data can include data associated with various types of species. The growth data can identify growth, regrowth, potential growth, etc., or any combination thereof. The species can include invasive species associated with regrowth. Alternatively or additionally, the growth can include the potential growth due to weather.

In some examples, the environmental factors data can include pests data and/or weeds data. The pests data can identify (e.g., include one or more identifiers utilized to identify) various types of pests. The pests can include beetles, such as invasive beetles. The weeds data can identify various types of weeds. The weeds can include invasive weeds that contribute to various types of changes in growth, etc., The environmental factors data can include fuel moisture data. The fuel moisture data can identify various types of fuel moisture.

In some examples, the environmental factors data can include fuel loads data. The fuel loads data can identify one or more fuel loads at one or more levels. The level(s) can include a level above the ground, a level below the ground, etc., or any combination thereof. The level(s) can be utilized, for instance, to identify fire behavior in a three-dimensional space. The level(s) can be utilized, for instance, to categorize what makes up a zone identified as a fire shed 108.

In some examples, the environmental factors data can include habitats data. The habitats data can identify one or more natural species habitats. The natural species habitats may affect ways in which a fire may be mitigated. For example, conservationists may fight to protect a natural species habitat that includes a tree. The tree, and a distance surrounding it, may be protected because it has an owl's nest in it. Any area within a distance of 100 meters from the owl's nest may be protected. As result, even though there may be a high fire danger, limitations (e.g., laws, rules, regulations, etc.) may be in place restricting removal of the tree and/or other trees, vegetation, etc., in the protected area.

In some examples, the environmental factors data can include trees data. The trees data can identify how long it has been since an area burned and/or how old the trees are.

In some examples, the environmental factors data can include policies data. The policies data can identify one or more policies. The policies data can identify how long it has been since a policy has changed for forest management in an area. For example, the policies data can identify policies on vegetation. The policies can be identified as important factors that can define a fire shed 108.

In some examples, the environmental factors data can include management data. The management data can identify whether an area encompasses a space that cannot be managed due to the area being remote, difficult to reach, difficult to access, difficult to enter, difficult to traverse, etc., or any combination thereof. For example, the management data can be utilized to identify individual ones of the fire sheds 108 as corresponding unmanaged fire sheds and/or corresponding managed fire sheds.

In some examples, the environmental factors data can include angle of incidence data. For example, the angle of incidence data can identify one or more angles of incident of sunlight in an area. The angles of incidence of sunlight may change a way that vegetation, trees, etc., may grow.

In some examples, the environmental factors data can include health indicators data. The health indicators data includes, for example, one or more heath indicators associated with vegetation.

In some examples, the environmental factors data can include index data. The index data can include normalized difference vegetation index (NDVI) data, enhanced water index (EWI) data, and/or one or more other types of index data. The NDVI, for example, may indicate how “green” an area is. The NDVI, for example, may be identified as a measurement of how green an area is. The EWI may be identified as a measurement of how much water is available to vegetation, trees, etc., in an area. The index data may be utilized to quantify the health of the vegetation and the landscape of an area.

In some examples, the environmental factors data can include geology data. For example, the geology data can identify a soil type, a subsurface type, etc., or any combination thereof. The surface may have dirt on top of the surface, and clay underneath the surface. Alternatively or additionally, the surface may have dirt on the top but rocks underneath. Contents of the surface and/or the subsurface may change what grows in the area. The content of the surface and/or the subsurface may affect and/or change a potential for a fire to burn under the ground. For instance, fires burning under the ground in some cases may burn, and/or have a likelihood of burning, longer than fires burning above the ground. The fires burning under the ground may burn relatively longer based on different contents in the subsurface. The fires burning under the ground may burn relatively longer based on peat moss and/or peat bog under the ground. The geology data can change fire behavior, and resultingly, the fire shed(s) 108 being identified thereby.

In some examples, the environmental factors data can include topology data. The topology data can identify a slope, an aspect (e.g., a direction of the slope), a landform, and/or one or more other types of topology data. The landform, for example, can be identified as a categorization of everything (e.g., the slope, the aspect, etc.) that is topologically related to an area. For example, one or more land features and/or a landform can be identified. The land features can include the slope, the aspect, a cliff, a canyon, etc., and/or one or more other land features. The land features, which can include particular land features being identified more precisely than the landform. The landform can be identified as a broad categorization of slopes, peaks, valleys, etc., or any combination thereof. you have your features which is like cliffs canyons and things like that which are not described particularly in slope.

In some instances, the land feature(s) can be identified instead of the landform. By identifying the land features instead of the landform, one or more features of the land which are not described particularly by just the slope, etc., can be identified based on the topology and the land type associated with an area of land.

In some examples, the environmental factors data can include wind pattern data. For instance, the wind pattern data can identify wind patterns. The wind patterns may be affected by other parts of the environmental factors data. For example, wind patterns may be affected by the topology. The wind patterns data may take into account additional data. The additional data can identify, for example, climactic level weather. The climactic level weather can include, for example, a precipitation volume, a precipitation frequency, etc., associated with an area. In some instances, precipitation metrics, such as precipitation frequency, may also be utilized to quantify drought. In some cases, drought may not be uniform across an entire landscape. In various cases, the topology may affect the weather, including the wind, associated with an area.

In some examples, the environmental factors data can include human factors data. For example, the human factors data can identify one or more human factors. The human factor(s) may be associated with a zone of transition between unoccupied land and human development. The zone of transition, for example, may include a wildland urban interface (WUI).

In some examples, the environmental factors data can include census tract level data. The census tract level data may be utilized to identify the fire shed(s) 108 and/or perform aggregation. For example, aggregation may include splitting a fire shed 108 because the resulting fire sheds 108 after the split capture actual aggregation totals better.

In some examples, the environmental factors data can include suppression factors data. For example, the suppression factors data can include a number of roads between a property and wildlands. The suppression factors data can include a number of roads between a pixel on map and the wildlands. In some cases, the roads may be utilized to identify lands as defensible targets. The suppression factors data may indicate how likely it is that the roads will suppress a fire between an area of land wildlands.

In some examples, the environmental factors data can include property value data. The property value data can identify a population density, an average income, a number of resources that are available to nearby firefighting agencies, an amount of time it would take firefighters (e.g., the nearest wildfire resource personnel) to respond to a fire and travel to an area. The property value data can identify the amount of time it would take the firefighters to get from the nearest wildfire resource center to an actual pixel. An area of land may be a relatively more defensible target against a wildfire can be identified via the property value data. The area of land being the relatively more defensible target may indicate a possible wildfire between the area and the wildlands can be suppressed relatively easily in comparison to areas that are less defensible targets.

In some examples, the environmental factors data can include historical boundaries data. The historical boundaries data can identify suppression patterns. The historical boundaries data can identify historical suppression patterns. The suppression patterns may be associated with defensive strategies associated with, and/or identified by, local agencies.

In some examples, the environmental factors data can include policy data. The policy data can identify one or more policies. The policy (ies) can include one or more state policies and/or one or more federal policies. The policy (ies) can be associated with forest management and firefighting.

In some examples, the environmental factors data can include financial data. The financial data can identify an amount of money that is spent per year on fire suppression for an area. The financial data can include a breakdown of the amount of the money. For example, the financial data can identify one or more fire mitigation plans that can be put in place. The fire mitigation plans may affect which areas are identified as the fire shed(s) 108.

In some examples, the environmental factors data can include private firefighting agencies data. For example, the private firefighting agencies data can identify one or more private firefighting agencies. The private firefighting agency (ies) may be associated with, and/or be more prominent in one or more areas (e.g., Beverly Hills). Individual ones of the private firefighting agency (ies) may be associated with corresponding homes (e.g., property (ies), etc.). The private firefighting agency (ies) may be utilized to defend the house in case of a wildfire.

In some examples, the environmental factors data can include aerial resource distance data. The include aerial resource distance data can include one or more distances of an area from one or more aerial resources. An area that is relatively further from a body of water may not be accessible for purposes of aerial based water suppression. The area that is relatively further from the body of water may require foam-based suppression in an occurrence of a wildfire.

In some examples, the environmental factors data can include climate data. For example, the climate data may be utilized to identify whether fire driven weather may affect a likelihood of a wildfire to occur in, and/or to spread to, an area. The climate data may identify whether there is a potential for a wildfire to grow big enough to generate its own weather. For example, the likelihood of the wildfire may be based on large-scale weather systems (e.g., Diablo winds, Santa Ana winds, etc.). The potential and/or qualification of an area for potentially experiencing wildfires may be based on a potential of an area for experiencing tornadoes and/or other mega-disasters.

In some examples, the environmental factors data can include embers data. For example, the embers data can identify a potential for embers. The potential for wildfires to start may be relatively greater because of embers. For example, even if an ember lands on a wet tree, the tree may not light on fire if the tree is not dry. However, if an ember lands on a dry tree, the potential for the tree to light on fire is relatively greater.

In some examples, the environmental factors data can include species distribution data. The species distribution data, for example, can identify whether large predators are present and/or likely to be present in an area. In some instances, a relatively greater number of herbivores in an area may increase a likelihood of a wildfire. In those or other instances, a relatively greater number of predators in an area may decrease a likelihood of a wildfire. Because a worsening vegetation landscape may result from relatively greater number of herbivores and/or a relatively smaller of predators, the chance of wildfires may be relatively greater. For instance, a larger number of wolves in an area may increase the health of a forest healthier and make it relatively less likely to experience damage resulting from a wildfire.

Although the various types environmental factors data can be utilized to identify any of the environment indicator data, as discussed above in the current disclosure it is not limited as such. Any other types of environmental factors data can be utilized to identify the environment indicator data. For example, the other types of environmental factors data can be utilized to identify, determine, generate, manage, and/or modify the fire shed data (e.g., the fire shed(s) 108.

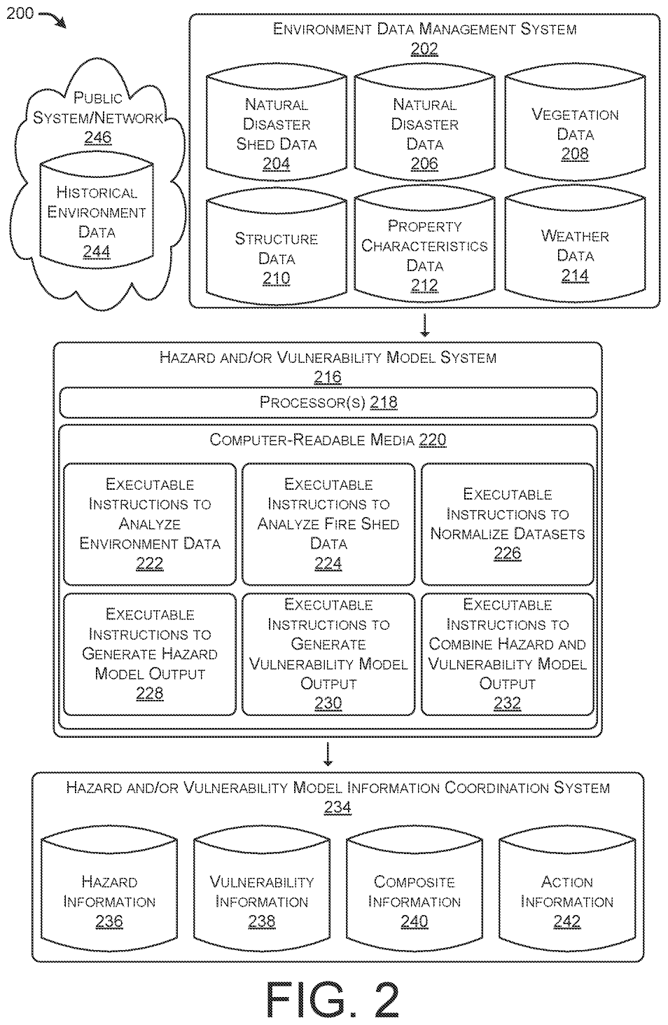

FIG. 2 depicts example systems 200 for performing hazard and/or vulnerability management utilizing natural disaster shed data. In some examples, the systems 200 can include an environment data management system 202 utilized to manage environment indicator data, including environment shed data (e.g., natural disaster shed data) (e.g., fire shed data) 204, natural disaster data (e.g., natural disaster risk indicator data) 206, vegetation data 208, structure data 210, property characteristic data 212, and weather data 214. In various implementations, the natural disaster shed data 204, the natural disaster data 206, the vegetation data 208, the structure data 210, the property characteristic data 212, and the weather data 214 can be implemented by the natural disaster shed data (e.g., the fire shed data), the natural disaster data (e.g., the natural disaster risk indicator data), the vegetation data, the structure data, the property characteristic data, and the weather data, respectively, as discussed above with reference to FIG. 1.

In some implementations, the systems 200 can include a hazard and/or vulnerability model system 216, which can include one or more processors 218 and one or more computer-readable media 220. In some examples, the hazard and/or vulnerability model system 216 is separate from the environment data management system 202. In alternative examples, any portion (e.g., a partial portion or an entire portion) of the hazard and/or vulnerability model system 216 is combined together, and/or integrated, with any portion (e.g., a partial portion or an entire portion) of the environment data management system 202.

In some examples, the hazard and/or vulnerability model system 216, the processor(s) 218, and the computer-readable media 220 can be implemented by, and/or be utilized to implement, the hazard and/or vulnerability model system 104, the processor(s) 112, and the computer-readable media 114, respectively, as discussed above with reference to FIG. 1.

Although the hazard and/or vulnerability model system 216, the processor(s) 218, and the computer-readable media 220 can be implemented by, and/or be utilized to implement, the hazard and/or vulnerability model system 104, the processor(s) 112, and the computer-readable media 114, respectively, as discussed above with reference to FIG. 1, as discussed above in the current disclosure, it is not limited as such.

In some examples, a portion (e.g., a partial portion or an entire portion) of the hazard and/or vulnerability model system 216 includes any portion (e.g., a partial portion or an entire portion) of the hazard and/or vulnerability model system 104. In those or other examples, a portion (e.g., a partial portion or an entire portion) of the hazard and/or vulnerability model system 104 includes any portion (e.g., a partial portion or an entire portion) of the hazard and/or vulnerability model system 216.

In some examples, the computer-readable media 220 includes executable instructions to analyze environment data 222, executable instructions to analyze fire shed data 224, executable instructions to normalize datasets 226, executable instructions to generate hazard model output 228, executable instructions to generate vulnerability model output 230, and/or executable instructions to combine hazard and vulnerability model output 232. In those or other examples, output of the hazard and/or vulnerability model system 216 can be provided to a hazard and/or vulnerability model information coordination system 234. In those or other examples, the output of the hazard and/or vulnerability model system 216 can be provided to the hazard and/or vulnerability model information coordination system 234 as hazard information 236, vulnerability information 238, and composite information 240.

In some examples, the hazard and/or vulnerability model information coordination system 234 is separate from the environment data management system 202 and/or the hazard and/or vulnerability model system 216. In alternative examples, any portion (e.g., a partial portion or an entire portion) of the hazard and/or vulnerability model system 216 is combined together, and/or integrated, with any portion (e.g., a partial portion or an entire portion) of the environment data management system 202 and/or any portion (e.g., a partial portion or an entire portion) of the hazard and/or vulnerability model system 216.

In some examples, the executable instructions to generate hazard model output 228, which can be executed by the hazard and/or vulnerability model system 216, the processor(s) 218, can be implemented by the hazard component 120, as discussed above with reference to FIG. 1. In those or other examples, the executable instructions to generate vulnerability model output 230, which can be executed by the hazard and/or vulnerability model system 216, the processor(s) 218, can be implemented by the vulnerability component 122, as discussed above with reference to FIG. 1. In those or other examples, the executable instructions to combine hazard and vulnerability model output 232, which can be executed by the hazard and/or vulnerability model system 216, the processor(s) 218, can be implemented by a combination of the hazard component 120 and the vulnerability component 122.

In some examples, the output of the hazard and/or vulnerability model system 216 can include a portion (e.g., a partial portion or an entire portion) of action information 242. In those or other examples, output of the hazard and/or vulnerability model information coordination system 234 can include a portion (e.g., a partial portion or an entire portion) of action information 242.

In some examples, the executable instructions to generate hazard model output 228 can be executed by the hazard and/or vulnerability model system 216 (e.g., the processor(s) 218) to generate the hazard information 236. In those or other examples, the executable instructions to generate vulnerability model output 230 can be executed by the hazard and/or vulnerability model system 216 (e.g., the processor(s) 218) to generate the vulnerability information 238. In those or other examples, the executable instructions to combine hazard and vulnerability model output 232 can be executed by the hazard and/or vulnerability model system 216 (e.g., the processor(s) 218) to generate the composite information 240.

In some examples, the executable instructions to analyze environment data 222 being executed by the hazard and/or vulnerability model system 216 (e.g., the processor(s) 218) can include at least one dataset (e.g., at least one portion of data, including the natural disaster data 206, the vegetation data 208, the structure data 210, the property characteristics data 212, the weather data 214, any other types of other environment indicator data (e.g., any of at least one portion of the other environment indicator data, as discussed above with respect to FIG. 1), or any combination thereof) of one or more datasets (e.g., one or more of the group of datasets, as discussed above with reference to FIG. 1) being analyzed by the hazard and/or vulnerability model system 216. In those or other examples, the executable instructions to analyze fire shed data 224 being executed by the hazard and/or vulnerability model system 216 (e.g., the processor(s) 218) can include at least one dataset (e.g., at least one portion of data, including the natural disaster data 206, overrun data, inundation data, any other types of environment indicator data (e.g., any of at least one portion of the environment indicator data, as discussed above with respect to FIG. 1), or any combination thereof) of the dataset(s) being analyzed by the hazard and/or vulnerability model system 216.

In various implementations, the executable instructions to normalize datasets 226 being executed by the hazard and/or vulnerability model system 216 (e.g., the processor(s) 218) can include any of at least one of the dataset(s) being normalized by the hazard and/or vulnerability model system 216. For example, the hazard and/or vulnerability model system 216 can normalize at least one of the dataset(s).

In some examples, normalizing the at least one of the dataset(s) can include identifying, for individual ones of the datasets, one or more thresholds. In those or other examples, individual ones of the threshold(s) can be utilized as alternative to other one or more other types of values (e.g., a median value for the dataset, such as if the dataset is provided as a gaussian distribution) to avoid overemphasizing various values of any datasets with respect to other datasets.

For instance, the threshold(s) can include a first threshold for a first value of flame length of 90 ft, a second threshold for a second value of flame length of 150 ft, etc., for a dataset associated with flame lengths. In those or other examples, normalizing the at least one of the dataset(s) can include normalizing, for individual ones of the dataset(s), one or more values (e.g., setting the first threshold as a 0.25 normalization value, setting the second threshold as a 0.75 normalization value, etc., for the dataset associated with flame lengths) to have normalization values between 0 and 1. The normalizing can be utilized to normalize spatial relationships among the dataset(s) such at the dataset(s) are independent of any particular measurement parameters (e.g., the flame lengths dataset, a wind speed dataset, a precipitation dataset, etc., any other types of the dataset(s), or any combination thereof, can be compared to any of at least one other of the dataset(s)).

In some implementations, the hazard and/or vulnerability model system 216 can select at least one of the normalized dataset(s) to be provided as a respective combined dataset to be analyzed via execution of the executable instructions to generate hazard model output 228, the executable instructions to generate vulnerability model output 230, and/or the executable instructions to combine hazard and vulnerability model output 232. For example, one or more input nodes of the hazard and/or vulnerability model system 216 can be activated (e.g., input nodes of at least one of the ML model(s)) to receive, as input data, a respective combined dataset that is normalized. The combined dataset can be utilized by the at least one of the ML model(s) to generate the hazard information 236, the vulnerability information 238, or the composite information 240, independent of any particular measurement parameter of a respective dataset, such that spatial relationships among the datasets may be processed according to normalized values of that data.

In various examples, any of the data being identified, determined, captured, managed, modified, analyzed, converted, etc., by, and/or for, the environment data management system 202, the hazard and/or vulnerability model system 216, and/or the hazard and/or vulnerability model information coordination system 234 can include the environment indicator data (e.g., any of the environment indicator data that is identified, determined, captured, managed, modified, analyzed, converted, etc., by the structure related devices, the natural disaster data source(s), any other devices, or any combination thereof), which can include proprietary data.

In some cases, the data being utilized to the hazard and/or vulnerability model system 216 to generate the information being output can include historic environment data 244, which is separate from the environment indicator data. The historic environment data 244 (e.g., publicly available data government data, etc.) can be identified, determined, captured, managed, modified, analyzed, converted, etc., a public system/network 246.

Although the historic environment data 244 can be separate from the environment indicator data, as discussed above in the current disclosure, it is not limited as such. In some examples, the environment indicator data can include the historic environment data 244.

Although the environment indicator data is discussed in various ways throughout the current disclosure, it is not limited as such. In some examples, any of the environment indicator data (e.g., the natural disaster indicator data) can be received (e.g., received by any sensors, devices, systems, sources, etc.), aggregated, and utilized to implement the environment indicator data for the purposes of performing any of the techniques as discussed herein.

In various implementations, utilizing the environment indicator data, which can include the proprietary data, by the hazard and/or vulnerability system 216, enables the hazard and/or vulnerability system 216 to generate output (e.g., the hazard and/or vulnerability output, as discussed above with reference to FIG. 1) of the hazard and/or vulnerability system 216. The hazard and/or vulnerability system 216 can generate the output (e.g., hazard and/or vulnerability output being generated based on the environment indicator data, which can include the proprietary data) with level of accuracy that is greater than any output of existing systems utilizing only publicly available data (e.g., data that includes the historic environment data 244).

The hazard and/or vulnerability model information coordination system 234 can include the hazard and/or vulnerability output (e.g., the output of the hazard and/or vulnerability model system 216), based on at least one of the data in the environment data management system 202, as discussed above in the current disclosure, although it is not limited as such. In some examples, the hazard and/or vulnerability output can be generated by the hazard and/or vulnerability model system 216 based on at least one of the natural disaster shed data 204, the natural disaster data 206, the vegetation data 208, the structure data 210, the property characteristics data 212, the weather data 214, and/or any other data received from various devices (e.g., the structure related devices, the disaster natural disaster data source(s), etc. In those or other examples, the hazard and/or vulnerability output can be generated by the hazard and/or vulnerability model system 216 based on omission of at least one other of the natural disaster data 206, the vegetation data 208, the structure data 210, the property characteristics data 212, the weather data 214, and/or any other data received from various devices.

As a hypothetical example, topography regions (e.g., water sheds), which can be identified based on sensor data, natural disaster source data, and/or land records, can be repurposed, redefined, modified, etc., to be fire sheds. Base on known correlations between topography regions being more likely to be in areas in which wildfires will occur, the topography regions being redefined as the fire sheds can be utilized to identify, with greater levels of accuracy, hazard scores and vulnerability scores using the hazard and/or vulnerability model information coordination system 234.

In the hypothetical example, natural disaster shed data 204 that includes the fire sheds can be utilized along with other data, which includes at least one of the natural disaster data 206, the vegetation data 208, the structure data 210, the property characteristics data 212, the weather data 214, to generate the hazard score, the vulnerability score, or the composite score. Generating the hazard score, the vulnerability score, or the composite score can include refraining from utilizing at least one other of the natural disaster data 206, the vegetation data 208, the structure data 210, the property characteristics data 212, or the weather data 214. Any of the least one other data not being utilized along with the fire sheds can be omitted based on lack of availability of the at least one other data, and/or, in some cases, if the at least one other data would contribute to results that would be inaccurate, if analysis of the at least one other data would be cumbersome, resources intensive, and/or time consuming, etc.

In some instances, a hazard model being operated via the executable instructions to generate hazard model output 228 does not utilize any structure data. For example, the output of the hazard model, which includes a hazard score indicating a likelihood of a portion of a structure (e.g., a pixel associated with the portion of the structure) being lost at a catastrophic event (e.g., a wildfire), is determined without input to the hazard model of any structure data. In some instances, the hazard model utilizes land use data.

In some instances, the hazard and/or vulnerability model system 216 can, to generate the hazard and/or vulnerability model output, utilize datasets that may have a relatively higher resolution than data utilized by existing systems. The higher resolution datasets can include i) data (e.g., insurance data) from various types of companies (e.g., insurance carriers), and/or ii) data gathered from homes (e.g., the structures). By utilizing the higher resolution datasets, a high level of accuracy of the output of the hazard and/or vulnerability model system 216 can be achieved.

By utilizing the higher resolution datasets, information (e.g., the hazard and/or vulnerability score) can be identified for a customized (e.g., specified) area. The dataset(s) can be utilized to obtain information associated with additional types of areas beyond the more limited types of areas (e.g., counties marked by county boundaries, zone code cells, etc.) utilized according to conventional technology.

In various examples, by utilizing the fire sheds (e.g., flood zones which are repurposed as fire zones (e.g., the fire sheds)) (e.g., “micro-sized” geographic zones), accuracy of the hazard and/or vulnerability model can be relatively higher. In contrast to conventional technology that does not use fire sheds, the hazard and/or vulnerability model system 216 improves accuracy of the output (e.g., the hazard and/or vulnerability score), by using the fire sheds as input (e.g., a shape of an area, such as a water shed, that would otherwise be occupied by water, can be redefined as a fire shed, based on patterns that have been identified and that indicate that fire sheds will likely be occupied by fire if a future wildfire is present in and/or near the area, such as within a threshold distance of the fire shed).

In some examples, the hazard and/or vulnerability score can be utilized for the actions performed utilizing the action information 242, and/or for identify insurance risks. For instance, a relatively higher risk indicated by a relatively greater hazard and/or vulnerability score (e.g. a relatively greater hazard score) can be utilized to generate a lower insurance amount, a relatively moderate risk indicated by a relatively moderate hazard and/or vulnerability score (e.g. a relatively moderate hazard score) can be utilized to generate a moderate insurance amount, a relatively lower risk indicated by a relatively lower hazard and/or vulnerability score (e.g. a relatively lower hazard score) can be utilized to generate a lower insurance amount, etc.

In various examples, the hazard and/or vulnerability score can be generated with respect to an amount of time being greater than a threshold amount of time (e.g., 1 year, 2 years, 5 years, 10 years, 30 years, etc.). By using the fire sheds, the hazard and/or vulnerability score for the land(s), the structure(s), the property (ies), etc., or any combination thereof, can be generated with respect to periods of time far into the future. In contrast to conventional technologies that may only be able to make accurate determinations of probabilities of natural disasters within amounts of time (e.g., 1 month, 6 months, etc.) in the near future, the input utilized by the hazard and/or vulnerability model system 216 enables the output, including the hazard and/or vulnerability score, to be accurately determined with respect to a time in the future being temporally beyond a current time by an amount that is greater than the threshold amount of time. While existing systems being utilized for natural disaster occurrence prediction/forecasting may only be accurate for much less than a single year, the system(s) (e.g., the hazard and/or vulnerability model system 216 according to the techniques discussed herein can utilize the environment indicator data to accurately generate output (e.g., output associated with damage and loss probabilities) (e.g., the hazard score, the vulnerability score, or the composite score), for time frames of more than one year (e.g., including, in some cases, much more than one year) into the future.

In some cases, any of the output information (e.g., the hazard information 236, the vulnerability information 238, and/or the composited information 240) that includes the score(s) (e.g., one or more scores with respect to a period of time) can be generated without regard to an amount of time (e.g., an initial period of time) that is less than or equal to a threshold amount of time. For example, any of the hazard score, the vulnerability score, and/or the composite score can be determined by omitting any applicability of the hazard score, the vulnerability score, and/or the composite score with respect to the amount of time being less than or equal to the threshold amount of time (e.g., one month, six months, one year, etc.).

By leaving out any applicability of the hazard score, the vulnerability score, and/or the composite score with respect to less than a year (e.g., including a margin of time beforehand or afterward, of any amount, such as a margin of time corresponding to 1%, 2%, etc. of the threshold amount of time) from a current time (e.g., by filtering out values related to a year or less, “giving or taking” the margin of time), for example, the output of the hazard and/or vulnerability model system 216 may be focused on a time frame that is most significant, most important, and/or of a highest priority, in order to optimize a level of efficiency with respect to the output (e.g., the hazard score, the vulnerability score, and/or the composite score). The unimportant time frame (e.g., the initial time frame) that is less relevant for generating the hazard score, the vulnerability score, and/or the composite score, for example, can be filtered out to focus the output of the hazard and/or vulnerability model system 216 to a relatively greater degree.

Although the fire shed(s) may be utilized to determine the hazard score, the vulnerability score, and/or the composite score with respect to “fires,” as discussed throughout the current disclosure, the term “fires” is utilized for convenience and simplicity of explanation. For example, excluding various other types of fires (e.g., home fires, such as “level 4” or “level 5” building fires), the term “fires” as it occurs throughout the current disclosure is utilized to refer to wildfires.

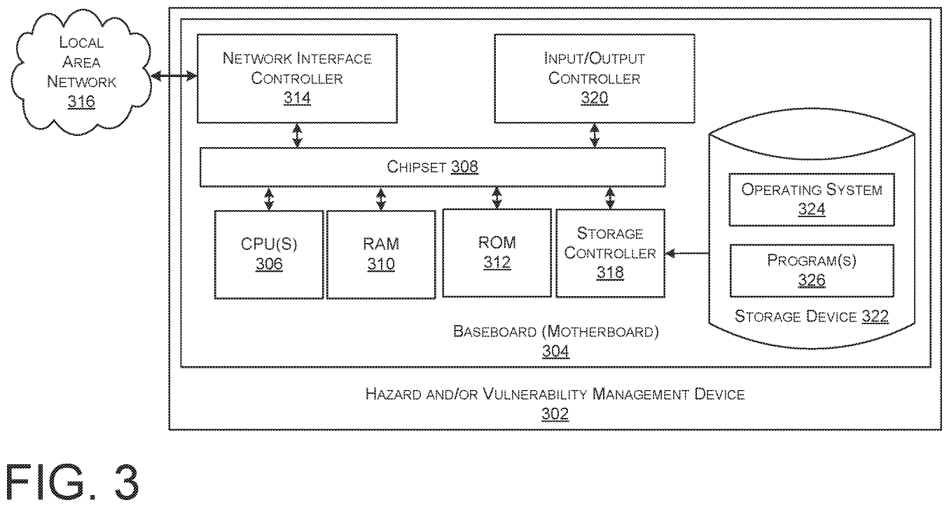

FIG. 3 shows an example computer architecture for a computing device (e.g., a server computer) 302 capable of executing program components for implementing the functionality described above. The computer architecture shown in FIG. 3 illustrates a conventional server computer, workstation, desktop computer, laptop, tablet, network appliance, e-reader, smartphone, or other computing device, and can be utilized to execute any of the software components presented herein. The computing device 302 may, in some examples, correspond to a physical server and may comprise networked devices such as servers, switches, routers, hubs, bridges, gateways, modems, repeaters, access points, etc. In some examples, the computing device 302 can be utilized to implement any of one or more devices in individual ones of the computing system(s) 102 in the hazard and/or vulnerability management system 104.

The computing device 302 includes a baseboard 304, or “motherboard,” which is a printed circuit board to which a multitude of components or devices can be connected by way of a system bus or other electrical communication paths. In one illustrative configuration, one or more central processing units (“CPUs”) 306 (e.g., the processor(s) 112, as discussed above with reference to FIG. 1) operate in conjunction with a chipset 308. The CPUs 306 can be standard programmable processors that perform arithmetic and logical operations necessary for the operation of the computing device 302.

The CPUs 306 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 308 provides an interface between the CPUs 306 and the remainder of the components and devices on the baseboard 304. The chipset 308 can provide an interface to a RAM 310, used as the main memory in the computing device 102. The chipset 308 can further provide an interface to a computer-readable storage medium such as a read-only memory (“ROM”) 312 or non-volatile RAM (“NVRAM”) for storing basic routines that help to startup the computing device 302 and to transfer information between the various components and devices. The ROM 312 or NVRAM can also store other software components necessary for the operation of the computing device 102 in accordance with the configurations described herein.

The computing device 302 can operate in a networked environment using logical connections to remote computing devices and computer systems through a network, such as a network 106. The chipset 308 can include functionality for providing network connectivity through a network interface controller (NIC) 314, such as a gigabit ethernet adapter. The NIC 314 is capable of connecting the computing device 302 to other computing devices over the network 316. In some examples, individual ones of one or more networks can be implemented according to the network 316, and utilized to implement the hazard and/or vulnerability management network 106. It should be appreciated that multiple NICs 314 can be present in the computing device 302, connecting the computer to other types of networks and remote computer systems.

The computing device 302 can be connected to a storage device 322 that provides non-volatile storage for the computing device 302. The storage device 322 can store one or more operating systems 324, one or more programs 326, and data, which have been described in greater detail herein. The storage device 322 can be connected to the computing device 302 through a storage controller 318 connected to the chipset 308. The storage device 322 can consist of one or more physical storage units. The storage controller 318 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 302 can store data on the storage device 322 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 322 is characterized as primary or secondary storage, and the like.

For example, the computing device 302 can store information to the storage device 322 by issuing instructions through the storage controller 318 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 302 can further read information from the storage device 322 by detecting the physical states or characteristics of one or more particular locations within the physical storage units.

In addition to the mass storage device 322 described above, the computing device 302 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 302. In some examples, the operations performed by the computing and networking architecture 100, and or any components included therein, may be supported by one or more devices similar to computing device 302. Stated otherwise, some or all of the operations performed by the computing and networking architecture 100, and or any components included therein, may be performed by one or more computing device 302 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disc (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 322 can store an operating system 324 utilized to control the operation of the computing device 302. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 322 can store other system or application programs and data utilized by the computing device 302.

In one embodiment, the storage device 322 or other computer-readable storage media is encoded with computer-executable instructions which, when loaded into the computing device 302, transform the computer from a general-purpose computing system into a special-purpose computer capable of implementing the embodiments described herein. These computer-executable instructions transform the computing device 302 by specifying how the CPUs 306 transition between states, as described above. According to one embodiment, the computing device 302 has access to computer-readable storage media storing computer-executable instructions which, when executed by the computing device 302, perform the various processes described above with regard to FIGS. 1 and 2. The computing device 302 can also include computer-readable storage media having instructions stored thereupon for performing any of the other computer-implemented operations described herein.

The computing device 302 can also include one or more input/output controllers 320 for receiving and processing input from a number of input devices, such as a keyboard, a mouse, a touchpad, a touch screen, an electronic stylus, or other type of input device. Similarly, an input/output controller 320 can provide output to a display, such as a computer monitor, a flat-panel display, a digital projector, a printer, or other type of output device. It will be appreciated that the computing device 302 might not include all of the components shown in FIG. 3, can include other components that are not explicitly shown in FIG. 3, or might utilize an architecture completely different than that shown in FIG. 3.

As described herein, one or more computers (e.g., the computing device 302 and/or one or more other computers) may comprise one or more the device(s) as discussed above with reference to FIG. 1. In various examples, computing device 302 may comprise individual ones of one or more devices being implemented as any of the devices and/or servers in any of the computing systems 102. The computer(s) may include one or more hardware processors (processors) configured to execute one or more stored instructions. The processor(s) may comprise one or more cores. Further, the computer(s) may include one or more network interfaces configured to provide communications between the computer(s) and other devices, such as the communications described herein as being performed by the computing systems 102, and/or one or more of any other devices communicatively coupled thereto. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs may comprise any type of programs or processes to perform the techniques described in this disclosure for providing hazard and/or vulnerability management utilizing natural disaster shed data. The programs may comprise any type of program that cause the computer(s) to perform techniques for communicating with other devices using any type of protocol or standard usable for determining connectivity.

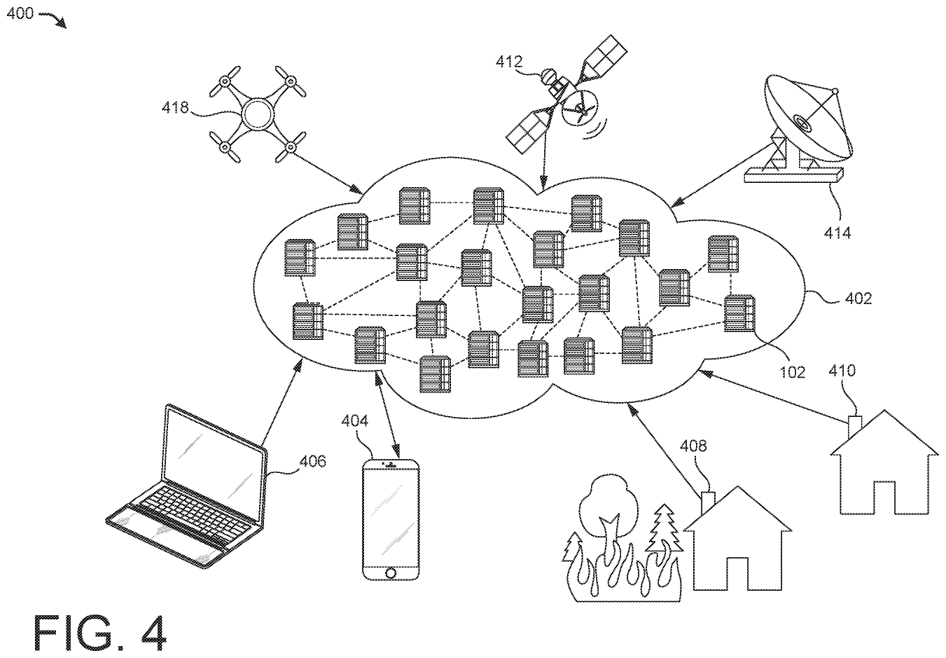

FIG. 4 depicts an example network environment 400 for performing hazard and/or vulnerability management utilizing natural disaster shed data. The environment 400 includes a cloud computing environment 402, having several computing devices (e.g., one or more devices utilized to implement the computing system(s) 102), connected to natural disaster data sources such as a smartphone 404, a laptop 406, structures 408 and 410, a satellite 412, a satellite receiver 414, and/or a drone 418.

For example, structure data (e.g., the structure data, as discussed above with reference to FIG. 1), may be received from structure 408 having one or more internet of things (IoT) devices that measures outside temperature, which may detect increased temperature indicative of natural disaster peril. The structure data may be received as a temperature dataset by the computing systems 102 with a temporal resolution as provided by the IoT device measuring the temperature. Accordingly, the computing system(s) 102 of the cloud computing environment 402 may communicate with the various natural disaster data sources to obtain or receive one or more datasets for processing or training of one or more machine learning (ML) models stored on respective computing system(s) 102 in the cloud computing environment 402.

In some implementations, at least one of the computing system(s) 102 may be implemented as at least one of any system (e.g., the environment data management system 202, the hazard and/or vulnerability model system 216, the hazard and/or vulnerability model information coordination system 234, any of one or more other systems, or any combination thereof. The cloud computing environment 402 may facilitate providing of the ML model(s) to calculate one or more scores (e.g., the hazard score, the vulnerability score, the composite score, or any combination thereof, as discussed above with reference to FIGS. 1-3), so as to not require each of the computing system(s) 102 to separately maintain datasets or labels data when datasets or labels data are acquired from the natural disaster data sources.

For example, one of the computing system(s) 102 may maintain a labels memory that stores labels data for any of the computing system(s) 102 of the cloud computing environment 402. Additionally or alternatively, one of the computing system(s) 102 may maintain a memory that stores datasets and/or structure data for any of the computing system(s) 102 of the cloud computing environment 402. As can be appreciated, the computing system(s) 102 shown in FIG. 4 are intended to be illustrative only in that the cloud computing environment 402 can communicate with any type of computerized device over any type of network and/or network/addressable connection (e.g., using a web browser).

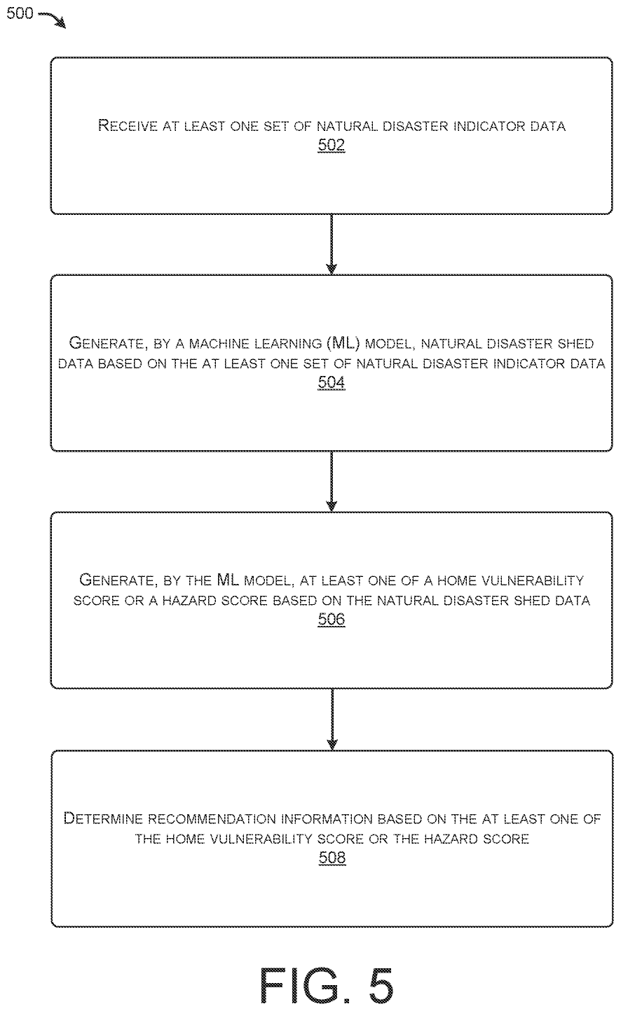

FIG. 5 depicts an example process 500 for performing hazard and/or vulnerability management utilizing natural disaster shed data.

At operation 502, the process can include receiving at least one set of natural disaster indicator data. The at least one set of natural disaster indicator data can include shed data, overrun data, inundation data, structure data, natural disaster risk indicator data, property characteristics data, weather data, vegetation data, and/or socio-economic data. In some examples, the natural disaster indicator data can include proprietary data received from structure related devices, natural disaster data sources, any other types of devices, or any combination thereof.

At operation 504, the process can include generating, by a machine learning (ML) model, natural disaster shed data based on the at least one set of natural disaster indicator data. The ML model can include, for example, a hazard model managed by a hazard component (e.g., the hazard component 120), a vulnerability model managed by a vulnerability component (e.g., the vulnerability component 122), or a composite mode (e.g., a combination of the hazard component 120 and the vulnerability component 122).

At operation 506, the process can include generating, by the ML model, at least one of a home vulnerability score or a hazard score based on the natural disaster shed data. In some examples, the home vulnerability score can be generated by the vulnerability component 122. In those or other examples, the hazard score can be generated by the hazard component 120.

At operation 508, the process can include determining recommendation information based on the at least one of the home vulnerability score or the hazard score. In some examples, the recommendation information can be determined by the action component 124. In those or other examples, the recommendation information can include mitigation information.

The functions described herein may be implemented in hardware, software executed by a processor, firmware, or any combination thereof. If implemented in software executed by a processor, the functions may be stored on or transmitted over as one or more instructions or code on a computer-readable medium. Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, optical disk storage, removable/non-removable computer-readable media, volatile/non-volatile computer-readable medium. magnetic disk storage, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above are also included within the scope of computer-readable media.

Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

From the foregoing it will be appreciated that, although specific examples have been described herein for purposes of illustration, various modifications may be made while remaining with the scope of the claimed technology. The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method comprising:
receiving at least one set of natural disaster indicator data;
generating, by a machine learning (ML) model, natural disaster shed data based on the at least one set of natural disaster indicator data;
generating, by the ML model, at least one of a home vulnerability score or a hazard score based on the natural disaster shed data; and
determining recommendation information based on the at least one of the home vulnerability score or the hazard score.

2. The method of claim 1, wherein the natural disaster shed data comprises fire shed data, the at least one set of natural disaster indicator data comprises topology region data, and
wherein generating the fire shed data further comprises:
generating, by the ML model, the fire shed data based on the topology region data.

3. The method of claim 1, wherein the natural disaster shed data comprises first natural disaster shed data of a first type, and
wherein generating the first natural disaster shed data further comprises:
identifying second natural disaster shed data of a second type based on the at least one set of natural disaster indicator data; and
generating, by the ML model, the first natural disaster shed data based on the second natural disaster shed data of the second type.

4. The method of claim 1, wherein the at least one set of natural disaster indicator data further comprises a plurality of sets of natural disaster indicator data,
wherein receiving the plurality of sets of natural disaster indicator data further comprises:
receiving the plurality of sets of natural disaster indicator data from a plurality of disparate data source devices; and
aggregating the plurality of sets of natural disaster indicator data as aggregated natural disaster indicator data, and
wherein generating the natural disaster shed data further comprises:
generating the natural disaster shed data based on the aggregated natural disaster indicator data.

5. The method of claim 1, wherein generating the at least one of the home vulnerability score or the hazard score further comprises:
generating the home vulnerability score and the hazard score,
further comprising:
identifying home vulnerability information associated with the home vulnerability score and the hazard score;
identifying risk mitigation information indicating at least one risk mitigation activity based on the home vulnerability information; and
causing presentation by a display of a user device, of the recommendation information and the risk mitigation information.

6. A system comprising:
one or more processors; and
one or more non-transitory computer-readable media storing instructions that, when executed by the one or more processors, cause the system to perform operations comprising:
receiving at least one set of environment indicator data;
generating, by a machine learning (ML) model, environment shed data based on the at least one set of environment indicator data;
generating, by the ML model, at least one of a home vulnerability score or a hazard score based on the environment shed data; and
determining recommendation information based on the at least one of the home vulnerability score or the hazard score.

7. The system of claim 6, wherein the environment shed data comprises fire shed data, the at least one set of environment indicator data comprises topology region data, and
wherein generating the fire shed data further comprises:
generating, by the ML model, the fire shed data based on the topology region data.

8. The system of claim 6, wherein the environment shed data comprises first environment shed data of a first type, and
wherein generating the first environment shed data further comprises:
identifying second environment shed data of a second type based on the at least one set of environment indicator data; and
generating, by the ML model, the first environment shed data based on the second environment shed data of the second type.

9. The system of claim 6, wherein the at least one set of environment indicator data further comprises a plurality of sets of environment indicator data,
wherein receiving the plurality of sets of environment indicator data further comprises:
receiving the plurality of sets of environment indicator data from a plurality of disparate data source devices; and
aggregating the plurality of sets of environment indicator data as aggregated environment indicator data, and
wherein generating the environment shed data further comprises:
generating the environment shed data based on the aggregated environment indicator data.

10. The system of claim 6, wherein generating the at least one of the home vulnerability score or the hazard score further comprises:
generating the home vulnerability score and the hazard score;
the operations further comprising:
identifying home vulnerability information associated with the home vulnerability score and the hazard score;
identifying risk mitigation information indicating at least one risk mitigation activity based on the home vulnerability information; and
causing presentation by a display of a user device, of the recommendation information and the risk mitigation information.

11. The system of claim 6, wherein the environment shed data is associated with first environment zone data of a first type, and the at least one set of environment indicator data comprises second environment zone data of a second type,
wherein generating the at least one of the home vulnerability score or the hazard score further comprises:
determining map data;
determining weather data;
determining image data based on the map data and the weather data,
processing, by the ML model, the map data, the weather data, the image data, and second environment zone data of a second type, to generate weight data associated with image pixels in the image data, the weight data representing at least one hazard zone in the second environment zone data;
generating, by the ML model, the environment shed data based on the weight data; and
generating, by the ML model, the at least one of the home vulnerability score or the hazard score based on the environment shed data, and
wherein the ML model comprises at least one of an ML neural network model, an ML deep learning model, or an ML decision tree model based on the at least one set of environment indicator data.

12. The system of claim 6, wherein the environment shed data comprises fire shed data,
wherein generating the at least one of the home vulnerability score or the hazard score further comprises:
analyzing, by the ML model, the fire shed data to determine the at least one of the home vulnerability score or the hazard score, the at least one of the home vulnerability score or the hazard score being associated with at least one of a physical structure in a first geographical area associated with at least one fire oriented hazard zone indicated in the fire shed data, the at least one fire oriented hazard zone being identified based on at least one non-fire oriented hazard zone in the at least one set of environment indicator data, the at least one non-fire oriented hazard zone being in a second geographical area represented by the at least one set of environment indicator data, the second geographical area overlapping the first geographical area.

13. The system of claim 6, further comprising:
receiving, in the at least one set of environment indicator data, structure data and property characteristics data; and
combining, at an input layer of the ML model, the structure data and the property characteristics data, such that the input layer is configured to feed a respective combined dataset, as input data, to at least one of a home vulnerability model of the ML model or a hazard model of the ML model or a vulnerability model of the ML model,
wherein generating the at least one of the home vulnerability score or the hazard score further comprises:
generating, via the at least one of the home vulnerability score or the hazard model, the at least one of the home vulnerability score or the hazard score, respectively.

14. The system of claim 6, wherein the at least one set of environment indicator data comprises at least one spatial layer of a geographic information system (GIS) map, and
wherein the at least one spatial layer represents at least one of parcel data or property characteristics data, the at least one of the parcel data or the property characteristics data being associated with at least one physical structure, and
wherein generating the at least one of the home vulnerability score or the hazard score further comprises:
generating, by the ML model, the at least one of the home vulnerability score or the hazard score, based on the at least one spatial layer representing at least one likelihood of destruction to the at least one physical structure.

15. The system of claim 6, wherein the at least one of the home vulnerability score or the hazard score is associated with at least one likelihood of at least one fire crew responsiveness action associated with at least one potential future environment in at least one proximity of at least one property.

16. The system of claim 6, wherein generating the environment shed data further comprises:
generating, using at least one of a home vulnerability model of the ML model or a hazard model of the ML model, the at least one of the home vulnerability score or the hazard score, respectively; and
outputting, by the ML model, at least one of at least one first pixel or at least one second pixel of image data, the at least one first pixel being associated with the home vulnerability score, the at least one second pixel being associated with the hazard score.

17. One or more non-transitory computer-readable media storing instructions executable by at least one processor, wherein the instructions, when executed by the at least one processor, cause the at least one processor to perform operations comprising:
receiving at least one set of environment indicator data;
generating, by a machine learning (ML) model, environment shed data based on the at least one set of environment indicator data;
generating, by the ML model, at least one of a home vulnerability score or a hazard score based on the environment shed data; and
determining recommendation information based on the at least one of the home vulnerability score or the hazard score.

18. The one or more non-transitory computer readable media of claim 17, wherein the environment shed data comprises fire shed data, the at least one set of environment indicator data comprises topology region data, and
wherein generating the fire shed data further comprises:
generating, by the ML model, the fire shed data based on the topology region data.

19. The one or more non-transitory computer readable media of claim 17, wherein the environment shed data comprises first environment shed data of a first type, and
wherein generating the first environment shed data further comprises:
identifying second environment shed data of a second type based on the at least one set of environment indicator data; and
generating, by the ML model, the first environment shed data based on the second environment shed data of the second type.

20. The one or more non-transitory computer readable media of claim 17, wherein the at least one set of environment indicator data further comprises a plurality of sets of environment indicator data,
wherein receiving the plurality of sets of environment indicator data further comprises:
receiving the plurality of sets of environment indicator data from a plurality of disparate data source devices; and
aggregating the plurality of sets of environment indicator data as aggregated environment indicator data, and
wherein generating the environment shed data further comprises:
generating the environment shed data based on the aggregated environment indicator data.
